(19) United States
(12) Patent Application Publication
(10) Pub. No.: US 2019/0139502 A1
(43) Pub. Date: May 9, 2019

(54) DISPLAY CONTROL APPARATUS

(71) Applicant: CANON KABUSHIKI KAISHA, Tokyo (JP)

(72) Inventors: Katsuyuki Onozawa, Kawasaki-shi (JP); Tomoki Kuroda, Tokyo (JP)

(21) Appl. No.: 16/239,731

(22) Filed: Jan. 4, 2019

Related U.S. Application Data
(63) Continuation of application No. PCT/JP2017/020182, filed on May 31, 2017.

(30) Foreign Application Priority Data
Jul. 6, 2016 (JP) 2016-134044

(51) Int. Cl. G09G 3/36; H04N 5/235

(52) U.S. Cl. CPC G09G 3/3607; H04N 5/2355; G09G 2320/0626; G09G 2320/066; G09G 2320/0233

(57) ABSTRACT

A display control apparatus according to the present invention includes: a first setting unit configured to set, in response to a user instruction, a processing parameter used for predetermined image processing; a processing unit configured to generate processed image data by performing the predetermined image processing on input image data using the processing parameter set by the first setting unit; a second setting unit configured to set a display mode specified by a user from among a plurality of display modes for displaying an image based on the processed image data on a display unit in a brightness range that differs from a brightness range of the input image data; and a recording unit configured to record, in a storage medium, information relating to the display mode set by the second setting unit together with the processing parameter set by the first setting unit.

### CROSS-REFERENCE TO RELATED APPLICATIONS

This application is a Continuation of International Patent Application No. PCT/JP2017/020182, filed May 31, 2017, which claims the benefit of Japanese Patent Application No. 2016-134044, filed Jul. 6, 2016, both of which are hereby incorporated by reference herein in their entirety.

### BACKGROUND OF THE INVENTION

### Field of the Invention

The present invention relates to a display control apparatus.

### Description of the Related Art

With advances in technology relating to display apparatuses, it is foreseeable that display apparatuses capable of displaying images having a wide brightness range (a wide dynamic range of brightness), highly realistic images, and so on will become widespread. For example, with improvements in the emission brightness (emission quantity) of backlight units, advances in technology relating to local dimming, and so on, it is foreseeable that liquid crystal display apparatuses capable of displaying images having a wide brightness range, highly realistic images, and so on will become widespread. In local dimming, the BL brightness (the emission brightness of the backlight unit) is partially changed so that the BL brightness in a dark portion of an image is lower than the BL brightness in a light portion of the image, for example. An image having a wide brightness range is known as an “HDR (High Dynamic Range” image” or the like.

A workflow (an image creation workflow) for creating image content such as digital cinema typically includes a photographing process and an editing process. The photographing process is a process for obtaining, by photographing, photographed image data (image data representing an image of a subject) constituted by digital image data. The photographing process is performed in a photographing location. The editing process is a process executed after the photographing process to edit the photographed image data obtained in the photographing process. The editing process is known as “post-production” or the like. In the editing process, color grading is performed to correct the look of the image to a desired look, for example. The editing process is performed in an editing location. The editing location is typically different from the photographing location. For example, the editing location is an editing studio.

In the editing process, operations are typically performed cooperatively by a large number of people, such as a creator (a producer) and a colorist. However, it is not always possible for the director of photography of the photographing process to participate in the editing process. In recent years, therefore, it is often the case that rough color grading (provisional color grading; on-set grading) is performed during the photographing process, and color grading (main color grading) for making fine adjustments to the look is performed during the editing process. By implementing provisional color grading during the photographing process, the mood of the final image can be broadly realized in the photographing process, and the workload of the main color grading performed during the editing process can be reduced.

Moreover, in recent years, HDR image data (image data representing an HDR image) are often obtained in the photographing process. In a photographing process for obtaining HDR image data, processing parameters used during the provisional color grading are recorded. Parameters defined by the ASC CDL (The American Society of Cinematographers Color Decision List), for example, are recorded as the processing parameters. In so doing, the worker who performs the main color grading can be notified of the processing parameters used during the provisional color grading. As a result, the work efficiency of the main color grading can be improved. Prior art relating to parameter recording is disclosed in PTLs 1 to 3, for example.

In a technique disclosed in PTL 1, a parameter applied when outputting photographed image data to the outside and a parameter used during post-photographing processing are recorded, and one of these two parameters is selected for use. In a technique disclosed in PTL 2, image data and processing parameters are recorded in association. In a technique disclosed in PTL 3, HDR image data, brightness characteristic information relating to the brightness expressed by the HDR image data, and definition information for converting the HI)R image data into SDR (Standard Dynamic Range) image data are recorded. SDR image data are image data representing an SDR image having a typical brightness range, which is narrower than the brightness range of an HDR image.

When HDR image data are obtained in the photographing process, a display apparatus (an HDR display apparatus) capable of displaying HDR images is preferably used as a display apparatus. However, depending on power supply limitations, baggage restrictions, and so on, it may be impossible during the photographing process to use an HDR display apparatus or to display HDR images on an HDR display apparatus. For example, during the photographing process, a display apparatus (an SDR display apparatus) that can display SDR images but not HDR images may be used, or images (SDR images) having a narrower brightness range than an HDR image may be displayed. During the editing process, on the other hand, HDR images are displayed using an HDR display apparatus.

FIG. 21 shows an example of the brightness range of an HDR image and the brightness range of an SDR image. An SDR image has a brightness range defined by standards such as ITU, Rec. 709. and DCI-P3, for example. An HDR image has a brightness range corresponding to a brightness contrast ratio (a contrast ratio of the brightness) of 400000:1 to 1000000:1, for example.

During the photographing process (provisional color grading), an SDR image corresponding to an HDR image is displayed in one of the following display modes 1 to 4, for example.

Display Mode 1

In display mode 1, images are displayed in a brightness range obtained by compressing the brightness range of input image data. FIG. 22 shows an example of a correspondence relationship between an uncompressed brightness range and a compressed brightness range. In the example shown in FIG. 22, the brightness range is compressed from a brightness range of 0 to 1000 cd/m² to a brightness range of 0 to 500 cd/m². Further, in the example shown in FIG. 22, the compressed brightness varies linearly relative to variation in the brightness prior to compression.

Display Mode 2

In display mode 2, an image region corresponding to a part of the brightness range of the input image data is displayed in a set brightness range, and in image regions not corresponding to this part of the brightness range of the input image data, predetermined display is performed. FIG. 23 shows an example of a correspondence relationship between an unconverted brightness range in display mode 2 and a converted brightness range in display mode 2. In the example shown in FIG. 23, a brightness range of 0 to 200 cd/m² is converted into a brightness range of 0 to 500 cd/m², and brightnesses between 200 and 1000 cd/m² are converted to 500 cd/m². Further, in the example shown in FIG. 23, in the unconverted brightness range of 0 to 200 cd/m², the converted brightness varies linearly relative to variation in the brightness prior to conversion.

Display Mode 3

In display mode 3, a partial image region is displayed at a set brightness, and other image regions are displayed at a reference brightness. More specifically, in display mode 3, in a partial image region of the HDR image, display is performed at a higher brightness than the reference brightness, and in the other image regions of the HDR image, display is performed at the reference brightness. The size of the partial image region, the brightness of the partial image region, and so on are determined on the basis of power supply limitations.

Display Mode 4

In display mode 4, the image is displayed after controlling the emission brightness of the backlight unit to a set emission brightness. More specifically, in display mode 4, the emission brightness of the backlight unit is controlled to an emission brightness specified by a user. The HDR image data are then corrected on the basis of the emission brightness of the backlight unit.

The brightness of the displayed image is dependent on the display mode. Therefore, when display is performed in a different display mode from a past display mode, even if identical processing parameters to the processing parameters used in the past are used, a display emulating the display displayed in the past display mode (an identical display to that of the past display mode) may not necessarily be realized. For example, even when identical processing parameters to the processing parameters used during the provisional color grading are used during the main color grading, the brightness of the displayed image may deviate from the brightness realized during the provisional color grading. When the parameters, information, and so on recorded in accordance with the techniques described in PTLs 1 to 3 are used, brightness deviation caused by differences in the display mode and so on cannot easily be reduced. Therefore, when the techniques described in PTLs 1 to 3 are used, a display emulating a display displayed in a past display mode cannot easily be realized.

Moreover, this problem occurs regardless of the method of checking the image. For example, when checking a moving image based on moving image data, a single frame of the moving image data may be recorded as still image data. Accordingly, a still image based on the recorded still image data may be checked. The problem described above occurs likewise in this case. More specifically, the brightness of the displayed still image may deviate from the brightness of the displayed moving image (the frame corresponding to the still image).

The present disclosure provides a technique with which a display emulating a display displayed in a past display mode can be realized easily.

### CITATION LIST

### Patent Literature

PTL 1 Japanese Patent Laid-Open No. 2009-21827

PTL 2 Japanese Patent Laid-Open No. 2014-107837

PTL 3 Japanese Patent Laid-Open No. 2015-5878

### SUMMARY OF THE INVENTION

The present invention in its first aspect provides a display control apparatus comprising at least one processor that operates as:

a first setting unit configured to set, in response to a user instruction, a processing parameter used for predetermined image processing;

a processing unit configured to generate processed image data by performing the predetermined image processing on input image data using the processing parameter set by the first setting unit;

a second setting unit configured to set a display mode specified by a user from among a plurality of display modes for displaying an image based on the processed image data on a display unit in a brightness range that differs from a brightness range of the input image data; and

a recording unit configured to record, in a storage medium, information relating to the display mode set by the second setting unit together with the processing parameter set by the first setting unit.

The present invention in its second aspect provides a display control apparatus comprising at least one processor that operates as:

a setting unit configured to set a display mode specified by a user from among a plurality of display modes for displaying an image based on input image data on a display unit in a brightness range that differs from a brightness range of the input image data;

a control unit configured to execute display control for displaying a moving image based on moving image data on the display unit in the display mode set by the setting unit,

a generating unit configured to generate a frame displayed by the display unit as still image data; and

a recording unit configured to record information relating the display mode set by the setting unit and the still image data in association with each other in a storage medium.

The present invention in its third aspect provides a display control apparatus that differs from the above mentioned display control apparatus, comprising at least one processor that operates as:

an obtaining unit configured to obtain information relating to a display mode, the information being recorded by the above mentioned display control apparatus; and

a control unit configured to execute display control for displaying an image based on input image data on a display unit on the basis of the information.

The present invention in its fourth aspect provides a display control method comprising:

setting, in response to a user instruction, a processing parameter used for predetermined image processing;

generating processed image data by performing the predetermined image processing on input image data using the set processing parameter;

setting a display mode specified by a user from among a plurality of display modes for displaying an image based on the processed image data on a display unit in a brightness range that differs from a brightness range of the input image data; and

recording, in a storage medium, information relating to the set display mode together with the set processing parameter.

The present invention in its fifth aspect provides a display control method comprising:

setting a display mode specified by a user from among a plurality of display modes for displaying an image based on input image data on a display unit in a brightness range that differs from a brightness range of the input image data;

executing display control for displaying a moving image based on moving image data on the display unit in the set display mode,

generating a frame displayed by the display unit as still image data; and

recording information relating the set display mode and the still image data in association with each other in a storage medium.

The present invention in its sixth aspect provides a display control method that differs from the above mentioned display control method, comprising:

obtaining information relating to a display mode, the information being recorded by the above mentioned display control method; and

executing display control for displaying an image based on input image data on a display unit on the basis of the information.

The present invention in its seventh aspect provides a non-transitory computer readable medium that stores a program, wherein the program causes a computer to execute the above mentioned display control method.

Further features of the present invention will become apparent from the following description of exemplary embodiments (with reference to the attached drawings).

### BRIEF DESCRIPTION OF THE DRAWINGS

FIG. 1 is a view showing an example configuration of an image processing system according to a first embodiment;

FIG. 2 is a view showing an example configuration of an on-set display apparatus according to the first embodiment;

FIGS. 3A and 3B are views showing examples of display modes according to the first embodiment;

FIG. 4 is a view showing an example of a processing flow of the on-set display apparatus according to the first embodiment;

FIG. 5 is a view showing an example of display information according to the first embodiment;

FIG. 6 is a view showing an example configuration of an editing display apparatus according to the first embodiment;

FIG. 7 is a view showing an example of a processing flow of the editing display apparatus according to the first embodiment;

FIG. 8 is a view showing an example configuration of an editing display apparatus according to a second embodiment;

FIG. 9 is a view showing an example of boost display according to a third embodiment;

FIG. 10 is a view showing an example configuration of an on-set display apparatus according to the third embodiment;

FIG. 11 is a view showing an example of a processing flow of the on-set display apparatus according to the third embodiment;

FIG. 12 is a view showing an example of display information according to the third embodiment;

FIG. 13 is a view showing an example configuration of an editing display apparatus according to the third embodiment;

FIG. 14 is a view showing an example of a processing flow of the editing display apparatus according to the third embodiment;

FIG. 15 is a view showing an example configuration of a display apparatus according to a fourth embodiment;

FIG. 16 is a view showing an example configuration of a display apparatus according to a fifth embodiment;

FIG. 17 is a view showing an example of an actual brightness and a brightness of a display range, according to the fifth embodiment;

FIG. 18 is a view showing an example of the actual brightness and the brightness of a display range, according to the fifth embodiment;

FIG. 19 is a view showing examples of a gamma curve, a display range, and a junction according to the fifth embodiment;

FIG. 20 is a view showing an example configuration of a display apparatus according to a sixth embodiment;

FIG. 21 is a view showing an example of a brightness range;

FIG. 22 is a view showing an example of brightness range compression; and

FIG. 23 is a view showing an example of brightness range conversion.

### DESCRIPTION OF THE EMBODIMENTS

First to sixth embodiments of the present invention will be described below. Note that the first to sixth embodiments described below are merely examples, and configurations obtained by amending or changing the configurations of the first to sixth embodiments appropriately within the scope of the spirit of the present invention are also included therein. Configurations obtained by appropriately combining the configurations of the first to sixth embodiments are also included in the present invention.

### First Embodiment

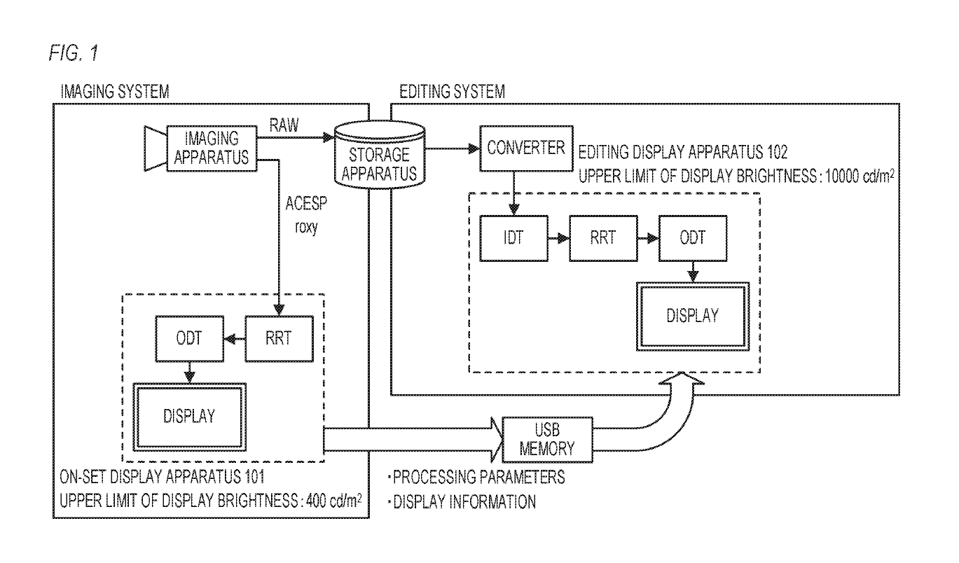

A first embodiment of the present invention will now be described. FIG. 1 shows an example configuration of an image processing system according to this embodiment. There are no particular limitations on standards for color management and so on, but in the image processing system shown in FIG. 1, the ACES (Academy Color Encode Specification) standard proposed by the Academy of Motion Picture Arts and Sciences (AMPAS) is used. The image processing system shown in FIG. 1 includes an imaging system and an editing system.

The imaging system is a system for carrying out photographing, and is used in a photographing location, for example. The imaging system includes an imaging apparatus (a digital camera) and an on-set display apparatus (a first display apparatus) 101. The editing system is a system for editing-subject image data, and is used in an editing location, for example. The editing system includes a converter and an editing display apparatus (a second display apparatus) 102.

An example of an operation performed using the image processing system shown in FIG. 1 will now be described. First, in the photographing location, provisional color grading is performed on photographed image data using the on-set display apparatus 101. The photographed image data are image data generated by performing photographing using the imaging apparatus, and represent an image of a subject. Provisional color grading is rough color grading, and may also be referred to as “on-set grading” or the like. Color grading is an operation for correcting the look of an image to a desired look. During the provisional color grading, the on-set display apparatus 101 displays an image (an image based on the photographed image data) in a set display mode. Next, in the editing location, main color grading is performed on the photographed image data using the editing display apparatus 102. Main color grading is more detailed color grading than the provisional color grading for making fine adjustments to the look, for example.

The respective apparatuses of the image processing system shown in FIG. 1 will now be described briefly. The imaging apparatus generates the photographed image data by photographing. There are no particular limitations on the brightness range (the dynamic range of the brightness (luminance)) of the photographed image data, but in this embodiment, image data having a wide brightness range (HDR (High Dynamic Range) image data) are generated as the photographed image data. HDR image data have a brightness range corresponding to a brightness contrast ratio (a contrast ratio of the brightness) of 400000:1 to 1000000:1, for example. Further, there are no particular limitations on the data format of the photographed image data. In this embodiment, image data having a RAW format (RAW image data), image data having an ACES Proxy format (ACES Proxy image data), and so on are generated as the photographed image data. The ACES Proxy format is a data format (a transmission format) defined by ACES (Academy Color Encoding System). ACES Proxy image data are generated by implementing data compression processing and the like on RAW image data. The imaging apparatus is capable of outputting the photographed image data to the outside. In this embodiment, the imaging apparatus outputs the ACES Proxy image data to the on-set display apparatus 101 and records the RAW image data in a storage apparatus.

There are no particular limitations on the brightness range (the display brightness range) that can be displayed by the on-set display apparatus 101. In this embodiment, an upper limit of the display brightness (the brightness of a screen; the displayed brightness) of the on-set display apparatus 101 is assumed to be 400 cd/m² (=400 nit). The on-set display apparatus 101 implements first image processing (predetermined image processing) on the ACES Proxy image data output from the imaging apparatus and displays an image on the basis of image data obtained as a result of the first image processing. The first image processing includes RRT (Reference Rendering Transform), ODT (Output Device Transform), and so on. RRT and ODT are processes defined by ACES.

RRT is processing for making an ACES space visible. An ACES space is a color space defined by the color management standard proposed by AMPAS (the Academy of Motion Picture Arts and Sciences), and is a color space (a linear space) that is shared by input and output apparatuses. RRT may also be referred to as “reference rendering conversion processing for converting ACES image data into OCES (Output Color Encoding Specification) image data conforming to a certain idealized display apparatus”. More specifically, RRT may also be referred to as “processing for converting ACES image data into OCES image data for realizing the look of a reference film tone”. RRT includes grayscale conversion processing using a lookup table (LUT), color correction processing using an LUT, and so on, for example. A one-dimensional lookup table, a three-dimensional lookup table, and so on are used as the LUTs. The ACES image data are image data in an ACES space, for example ACES Proxy image data.

ODT is output apparatus conversion processing for converting the OCES image data obtained by RRT in accordance with the output apparatus. ODT may also be referred to as “processing for converting OCES image data into image data in the unique color space of the output apparatus”, ODT includes grayscale conversion processing using a one-dimensional lookup table, color correction processing using a one-dimensional lookup table, and so on, for example.

In the on-set display apparatus 101, as a result of RRT and ODT, ACES Proxy data are converted into image data in the unique color space of the on-set display apparatus 101.

The converter converts the RAW image data recorded in the storage apparatus into image data having a predetermined data format and outputs the converted image data to the editing display apparatus 102.

There are no particular limitations on the display brightness range of the editing display apparatus 102, but in this embodiment, the upper limit of the display brightness of the editing display apparatus 102 is assumed to be 10000 cd/m². The editing display apparatus 102 implements second image processing (predetermined image processing) on the image data output from the converter, and displays an image on the basis of image data obtained as a result of the second image processing. The second image processing includes IDT (Input Device Transform), RRT, ODT, and so on. IDT is processing defined by ACES for converting image data in the unique color space of the imaging apparatus into ACES data.

In the editing display apparatus 102, as a result of IDT, RRT, and ODT, the image data output from the converter are converted into image data in the unique color space of the editing display apparatus 102. Note that in the editing display apparatus 102, conversion processing for converting the grayscale characteristic of the image data so as to match a grayscale characteristic conforming to SMPTE ST-2084 (a grayscale characteristic based on a human visual Characteristic) may be performed instead of ODT. This conversion processing may also be performed in addition to ODT. The grayscale characteristic is a characteristic indicating a correspondence relationship between a grayscale value and a brightness.

In this embodiment, the on-set display apparatus 101 is capable of recording processing parameters used during the provisional color grading (the image processing performed during the provisional color grading) in a USB memory (a storage unit). The editing display apparatus 102 is capable of reading the processing parameters used during the provisional color grading from the USB memory and using the read processing parameters during the main color grading (the image processing performed during the main color grading). Further, the on-set display apparatus 101 is capable of recording display information indicating the display mode set in relation to the on-set display apparatus 101 in the USB memory. Accordingly, the editing display apparatus 102 is capable of reading the display information from the USB memory and displaying an image in the display mode indicated by the read display information. As a result, the editing display apparatus 102 can easily realize a display emulating the display displayed in the display mode of the on-set display apparatus 101 during the provisional color grading. For example, the editing display apparatus 102 can easily reproduce the display displayed by the on-set display apparatus 101 during the provisional color grading.

Note that there are no particular limitations on a method for transmitting the processing parameters, the display information, and so on from the on-set display apparatus 101 to the editing display apparatus 102. For example, the information may be transmitted from the on-set display apparatus 101 to the editing display apparatus 102 via a different portable medium from the USB memory. The information may also be transmitted from the on-set display apparatus 101 to the editing display apparatus 102 via another apparatus capable of storing information. The other apparatus may be connected directly to the on-set display apparatus 101 and the editing display apparatus 102, but does not have to be. The other apparatus may be connected to the on-set display apparatus 101 and the editing display apparatus 102 via the Internet or the like.

There are also no particular limitations on the processing parameters. For example, the processing parameters may be parameters used in different image processing from the image processing performed during the color grading. Image processing using processing parameters includes brightness adjustment processing, color adjustment processing, blurring processing, edge emphasizing processing, tone curve adjustment, matrix conversion, and so on. Parameters defined by the ASC CDL (The American Society of Cinematographers Color Decision List) can be used as the processing parameters. On the ASC CDL, SLOPE, OFFSET, POWER, and SATURATION are defined as parameters. The SLOPE parameter is a gain value by which each grayscale value of the image data is multiplied. The OFFSET parameter is an offset value that is added to or subtracted from each grayscale value of the image data. The POWER parameter is a gamma value of gamma conversion implemented on the image data. The SATURATION parameter is a chroma gain value by which each chroma value of the image data is multiplied.

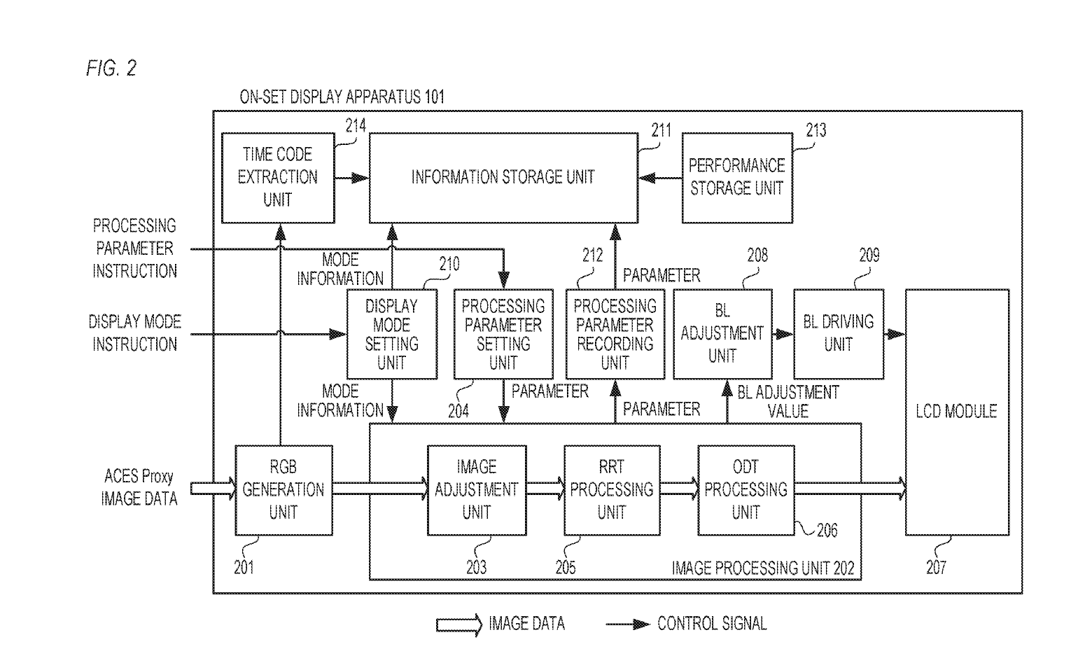

FIG. 2 is a block diagram showing an example configuration of the on-set display apparatus 101. There are no particular limitations on the display performance of the on-set display apparatus 101 and the display performance of the editing display apparatus 102, but in this embodiment, the display performance of the on-set display apparatus 101 is assumed to be poorer than the display performance of the editing display apparatus 102. For example, the on-set display apparatus 101 is a display apparatus having a narrower display brightness range than the brightness range of HDR image data, while the editing display apparatus 102 is a display apparatus having a display brightness range that equals or exceeds the brightness range of HDR image data. More specifically, the on-set display apparatus 101 is an SDR (Standard Dynamic Range) display apparatus, an HDR display apparatus having a restricted display brightness range, or the like. The editing display apparatus 102 is an HDR display apparatus having an unrestricted display brightness range or the like. An SDR display apparatus is a display apparatus that is incompatible with HDR image data but compatible with SDR image data (image data representing an SDR image having a typical brightness range that is narrower than the brightness range of an HDR image). An HDR display apparatus is a display apparatus that is compatible with HDR image data. SDR image data have a brightness range defined by standards such as ITU, Rec. 709, and DCI-P3, for example.

The ACES Proxy image data (input image data of the on-set display apparatus 101 image data input into the on-set display: apparatus 101) output from the imaging apparatus are input into an RGB generation unit 201. The RGB generation unit 201 separates the ACES Proxy image data into ACES_RGB image data, which are RGB image data, and other additional information. Here, the ACES_RGB image data have a grayscale characteristic (a linear characteristic) by which the grayscale value (an R value, a G value, and a B value) varies linearly relative to variation in the subject brightness, and have a color reproducibility by which the colors of the subject are represented faithfully. Processing for obtaining the ACES_RGB image data from the ACES Proxy image data (processing for converting the ACES Proxy image data into the ACES_RGB image data) includes de-gamma processing, color reproducibility correction processing, color space conversion processing, and so on, for example.

The ACES_RGB image data are input into an image processing unit 202. The image processing unit 202 implements predetermined image processing on the ACES_RGB image data, and outputs image data and so on obtained as a result of the predetermined image processing. The image processing unit 202 includes an image adjustment unit 203, an RRT processing unit 205, and an ODT processing unit 206.

The ACES_RGB image data are input into the image adjustment unit 203. The image adjustment unit 203 implements provisional color grading processing on the ACES_RGB image data in response to an instruction from a user (a user operation on the on-set display apparatus 101). As a result, processed image data are generated. The provisional color grading processing is image processing performed during provisional color grading. The image adjustment unit 203 outputs the processed image data to the RRT processing unit 205.

More specifically, a processing parameter setting unit 204 determines the processing parameters in response to an instruction from the user, and sets the determined processing parameters in the image processing unit 202 (the image adjustment unit 203). The image adjustment unit 203 then implements provisional color grading processing using the set processing parameters on the ACES_RGB image data.

The RRT processing unit 205 implements RRT on the processed image data output from the image adjustment unit 203 and outputs image data obtained as a result of the RRT to the ODT processing unit 206.

The ODT processing unit 206 implements ODT processing on the image data output from the RRT processing unit 205. As a result, image data in the unique color space of an LCD module 207 are generated. Further, the ODT processing unit 206 generates a BL adjustment value so that an image based on the input image data (specifically, the processed image data) is displayed favorably. The LCD module 207 includes a liquid crystal panel serving as a display panel and a backlight unit serving as a light-emitting unit. The BL adjustment value is a value relating to the emission brightness (the emission quantity) of the backlight unit. The ODT processing unit 206 outputs image data obtained as a result of the ODT processing to the LCD module 207 and outputs the BL adjustment value to a BL adjustment unit 208.

More specifically, a display mode setting unit 210 selects one of a plurality of display modes in response to an instruction from the user, and sets mode information relating to the selected display mode in the image processing unit 202 (the ODT processing unit 206). The mode information includes information indicating the display mode, display parameters used in the display mode, and so on. The ODT processing unit 206 then generates ODT-processed image data and the BL adjustment value on the basis of the image data from the RRT processing unit 205 and the mode information from the display mode setting unit 210. In this embodiment, the ODT-processed image data and the BL adjustment value are generated so that an image based on the input image data (the processed image data) is displayed in the set display mode. Further, the display mode setting unit 210 records the currently set mode information in an information storage unit 211 at a predetermined timing as a part of display information.

Note that the information storage unit 211 may be either a storage unit built into the on-set display apparatus 101 or a storage unit that can be attached to and detached from the on-set display apparatus 101. In this embodiment, the aforementioned USB memory is used as the information storage unit 211. Further, depending on the type of the input image data of the on-set display apparatus 101, the environment in which the on-set display apparatus 101 is used, and so on, the processing for selecting the display mode and setting the mode information may be performed automatically. Moreover, processing taking account of the mode information may be included in the provisional color grading processing, RRT, and so on. Furthermore, processing taking account of the mode information may be performed independently of the provisional color grading processing, RRT, ODT, and so on.

The BL adjustment unit 208 generates a BL control signal in accordance with the BL adjustment value output from the ODT processing unit 206. The BL adjustment unit 208 then outputs the generated BL control signal to a BL driving unit 209. The BL control signal is a signal relating to the emission brightness of the backlight unit.

Light from the backlight unit is emitted onto a back surface of the liquid crystal panel. By transmitting the light from the backlight unit through the liquid crystal panel, an image is displayed on the screen. When the ODT-processed image data are input into the LCD module 207, a transmittance of the liquid crystal panel (the transmittance at which the light from the backlight unit is transmitted through the liquid crystal panel) is controlled in accordance with the ODT-processed image data. When the BL control signal is input into the BL driving unit 209, the BL driving unit 209 controls the emission brightness of the backlight unit in accordance with the BL control signal. As a result, an image based on the input image data (the processed image data) is displayed in the set display mode. “Processing for outputting the ODT-processed image data to the LCD module 207” may also be referred to as “processing for controlling the transmittance of the LCD module 207”.

Hence, in this embodiment, the image processing unit 202 (the ODT processing unit 206) controls the transmittance of the liquid crystal panel, and the BL driving unit 209 controls the emission brightness of the backlight unit. As a result, an image based on the input image data (the processed image data) is displayed on the LCD module 207 in the set display anode. In this embodiment, therefore, image control for displaying an image based on the input image data (the processed image data) on the LCD module 207 in the set display mode is performed by the image processing unit 202 (the ODT processing unit 206) and the BL driving unit 209.

A processing parameter recording unit 212 obtains the currently set processing parameters from the image processing unit 202 (the image adjustment unit 203). The processing parameter recording unit 212 then records the obtained processing parameters (the currently set processing parameters) in the information storage unit 211 at a predetermined timing as a part of the display information. Note that the currently set processing parameters may also be obtained from the processing parameter setting unit 204.

Performance information indicating the display performance of the on-set display apparatus 101 (the display brightness range, the upper limit of the display brightness, settable display modes, settable parameters, and so on) is recorded in a performance storage unit 213 in advance. The performance storage unit 213 records the performance information in the information storage unit 211 at a predetermined timing as a part of the display information. The performance information may be obtained from the outside.

The additional information obtained by the RGB generation unit 201 is input into a time code extraction unit 214. The time code extraction unit 214 extracts a time code of the image data (the frame) serving as the current processing subject from the additional information. The time code extraction unit 214 then records the extracted time code (the time code of the image data (the frame) serving as the current processing subject) in the information storage unit 211 at a predetermined timing as a part of the display information.

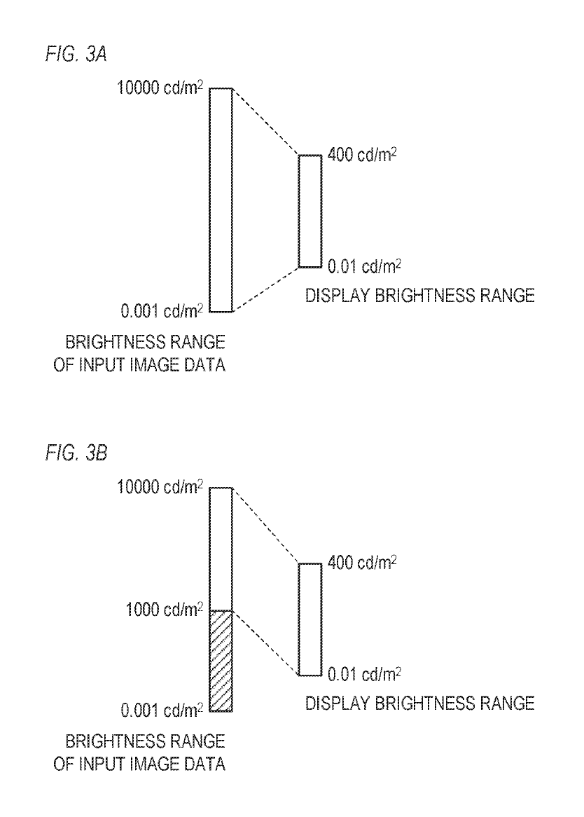

FIGS. 3A and 3B show examples of display modes according to this embodiment. More specifically, FIG. 3A shows a compression mode and FIG. 3B shows a clip mode.

The compression mode is a display mode in which simple compression display is performed. In simple compression display, an image is displayed in a brightness range obtained by compressing the brightness range of the input image data. In the simple compression display performed by the on-set display apparatus 101, all or a part of the display brightness range of the on-set display apparatus 101, for example, is used as the compressed brightness range. In the example shown in FIG. 3A., the brightness range (0.001 to 10000 cd/m²) of the input image data is compressed to the display brightness range (0.01 to 400 cd/m²) of the on-set display apparatus 101.

The clip mode is a display mode in which clip display is performed. In clip display, an image region corresponding to a part (a clip range) of the brightness range of the input image data is displayed in a set brightness range, and in image regions not corresponding to this part of the brightness range of the input image data, predetermined display is performed. In the clip display performed by the on-set display apparatus 101, all or a part of the display brightness range of the on-set display apparatus 101, for example, is used as the set brightness range. In the example shown in FIG. 3B, a part (1000 to 10000 cd/m²) of the brightness range (0.001 to 10000 cd/m²) of the input image data is converted to the display brightness range (0.01 to 400 cd/m²) of the on-set display apparatus 101. In this case, predetermined display is performed in image regions having lower brightnesses than 1000 cd/m². For example, lower brightnesses than 1000 cd/m² are displayed at 0 cd/m².

Note that when a maximum brightness of the clip range (a part of the brightness range of the input image data) is lower than a maximum brightness of the brightness range of the input image data, predetermined image display is performed in image regions having, higher brightnesses than the maximum brightness of the clip range, For example, higher brightnesses than the maximum brightness of the clip range are displayed at an identical brightness to the upper limit of the display brightness of the on-set display apparatus 101.

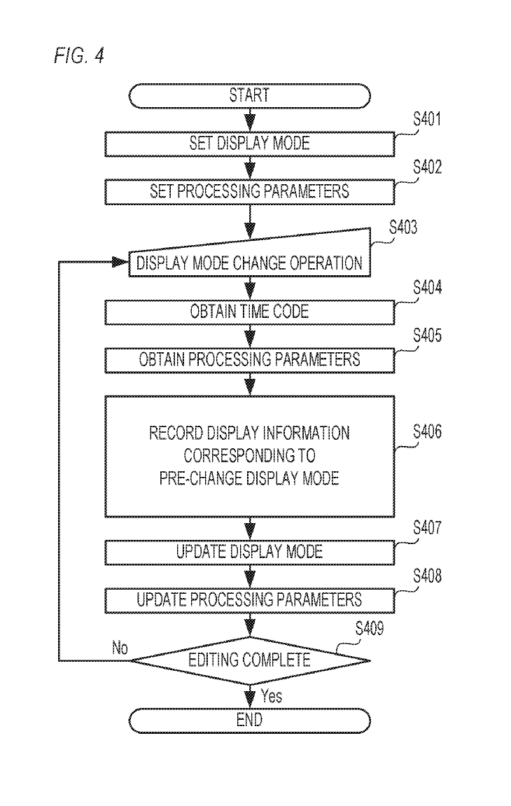

FIG. 4 is a flowchart showing an example of a processing flow of the on-set display apparatus 101. The processing flow shown in FIG. 4 is started in response to a provisional color grading start operation executed on the on-set display apparatus 101, for example. The provisional color grading start operation is a user operation for issuing an instruction to start the provisional color grading.

First, in S401, the display mode setting unit 210 selects one of the plurality of display modes in response to an instruction from the user, and sets mode information relating to the selected display anode in the image processing unit 202 (the ODT processing unit 206).

Next, in S402, the processing parameter setting unit 204 determines the processing parameters in response to an instruction from the user, and sets the determined processing parameters in the image processing unit 202 (the image adjustment unit 203). As a result, processed image data are generated using the set processing parameters, and an image based on the processed image data is displayed in the set display mode.

Next, in S403, the user performs a display mode change operation (a user operation for issuing an instruction to change the display mode) on the on-set display apparatus 101. For example, the user broadly determines the processing parameters by implementing provisional color grading in the compression mode, in which the entire brightness range of the input image data is used. Next, the user performs a display mode change operation to change the display mode to the clip mode, in which a part of the brightness range of the input image data is extracted and used. The user then determines the processing parameters in detail by implementing provisional color grading in the clip mode. Note that “a plurality of display modes having different display parameters” may also be referred to as “a plurality of different display modes”. Hence, change of the display mode may also involve change of the display parameters. When a display mode change operation has been executed, the processing of S404 to S408 is performed, and when a display mode change operation has not been executed, the processing advances to S409.

In S404, the time code extraction unit 214 extracts the time code of the image data (the frame) serving as the processing subject of the display mode change operation from the additional information.

In S405, the processing parameter recording unit 212 obtains the processing parameters set at the time of the display mode change operation from the image processing unit 202.

In S406, the display information corresponding to the pre-change display mode is recorded in the information storage unit 211. More specifically, the display mode setting unit 210 records the mode information set at the time of the display mode change operation in the information storage unit 211 as a part of the display information corresponding to the pre-change display mode, the processing parameter recording unit 212 records the processing parameters obtained in S405 in the information storage unit 211 as a part of the display information corresponding to the pre-change display mode, the performance storage unit 213 records the performance information in the information storage unit 211 as a part of the display information corresponding to the pre-change display mode, and the time code extraction unit 214 records the time code extracted in S404 in the information storage unit 211 as a part of the display information corresponding to the pre-change display mode.

In S407, the display mode setting unit 210 selects the post-change display mode in accordance with the display mode change operation performed in S404, and sets the mode information relating to the selected display mode in the image processing unit 202 (the ODT processing unit 206). As a result, the set mode information is updated and the display is updated.

In S408, the processing parameter setting unit 204 determines (changes) the processing parameters in response to an instruction from the user and sets the determined processing parameters in the image processing unit 202 (the image adjustment unit 203). As a result, the set processing parameters are updated and the display is updated. The processing then advances to S409.

In S409, the on-set display apparatus 101 (for example, a control unit, not shown, provided in the on-set display apparatus 101) determines whether or not a provisional color grading termination operation has been performed on the on-set display apparatus 101. The provisional color grading termination operation is a user operation for issuing an instruction to terminate the provisional color grading. When a provisional color grading termination operation has not been performed, the processing returns to S403, and when a provisional color grading termination operation has been performed, the processing flow is terminated.

According to the processing flow shown in FIG. 4, the display information is recorded in the information storage unit 211 in response to variation in the set mode information. Note that there are no particular limitations on the timing at which to record the display information. For example, the display information may be recorded in response to variation in the display brightness of the on-set display apparatus 101. The display information may also be recorded in response to a recording operation performed on the on-set display apparatus 101. The recording operation is a user operation for issuing an instruction to record the display information. The display information may also be recorded periodically at predetermined time intervals. There are no particular limitations on the data format of the display information. For example, a data file of the display information may be generated by adding other information to a data file of the processing parameters. The other data file associated with the data file of the processing parameters may be generated as a data file of different information from the processing parameters, or a combination of the processing parameters and the other data file may be generated as the data file of the display information.

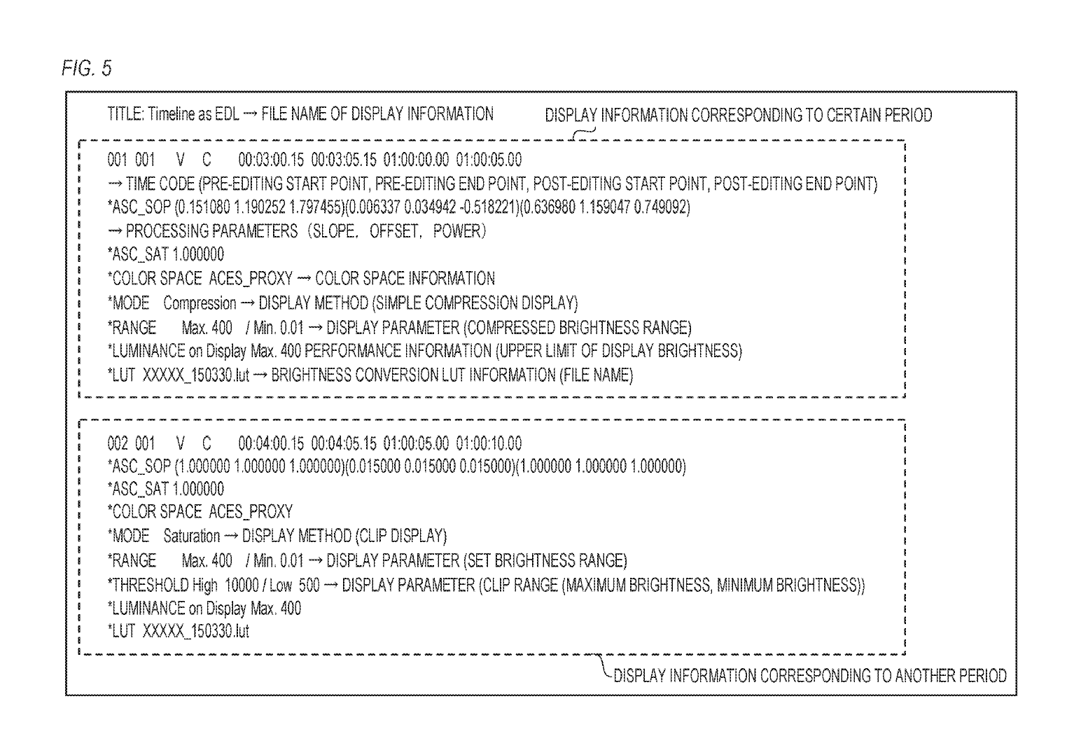

FIG. 5 shows an example of the display information. FIG. 5 shows an example of a case in which the parameters defined by the ASC CDL are used as the processing parameters. FIG. 5 also shows an example of a case in which a data file of the display information is generated by adding other information to the data file of the processing parameters.

In the example shown in FIG. 5, the display information includes the time code, the processing parameters, color space information, information indicating the display mode, the display parameter, and the performance information. The color space information is information indicating the color space of the input image data of the on-set display apparatus 101. More specifically, the color space information is information indicating the color space of the image data used in the provisional color grading processing. The display information shown in FIG. 5 is the display information of a certain period. In the example shown in FIG. 5, the time code of a start point of the corresponding period and the time code of an end point of the corresponding period are included in the display information. Further, when a partial scene is cut from moving image data or a scene is added to moving image data, the time code varies. In the example shown in FIG. 5, a time code prior to this type of editing and a time code following the editing are included in the display information. In the example shown in FIG. 5, brightness conversion LUT information is also included in the display information. The brightness conversion LUT information is information indicating the LUT used by the on-set display apparatus 101 (the LUT for converting the brightness). In the example shown in FIG. 5, a parameter indicating the compressed brightness range is described as the display parameter used during simple compression display. Further, in the example shown in FIG. 5, a parameter indicating the clip range and a parameter indicating the set brightness range are included as the display parameters used during clip display. The color space information and the brightness conversion LUT information are recorded by the processing parameter recording unit 212, for example.

Note that the display information is not limited to the display information shown in FIG. 5. For example, a set value of an image quality mode for changing the image quality of the displayed image (the image displayed on the screen), a set value of a picture mode for changing the atmosphere of the displayed image, and so on may be described as the information relating to the display mode. In the example shown in FIG. 5, display information corresponding to a frame is described, but display information corresponding to a scene or display information corresponding to the input image data as a whole may be described instead.

In this embodiment, it is possible to select a plurality of display modes (display parameters) in relation to a single frame, a single scene, the input image data as a whole, and so on. When a plurality of display modes are selected, information indicating each of the plurality of display modes is described in the display information. Further, when a plurality of display modes are selected, pluralities of processing parameters corresponding respectively to the plurality of display modes can be set individually. When pluralities of processing parameters corresponding respectively to the plurality of display modes are set, the pluralities of processing parameters are described in the display information.

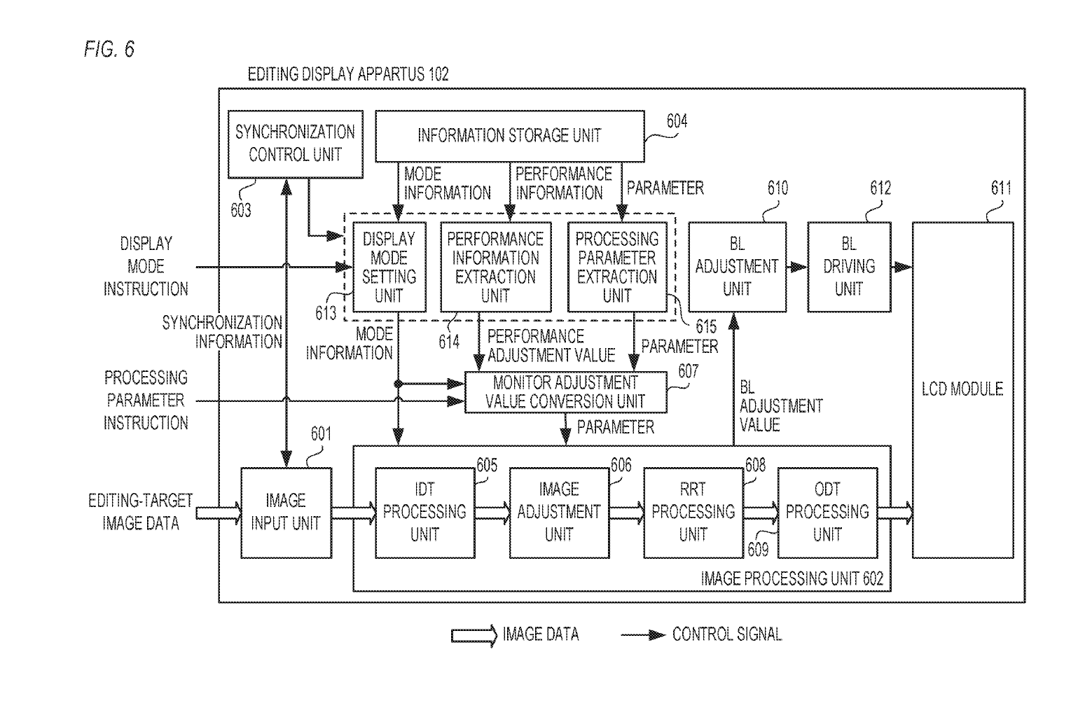

FIG. 6 is a block diagram showing an example configuration of the editing display apparatus 102. The image data output from the converter (input image data of the editing display apparatus 102; image data input into the editing display apparatus 102, editing-subject image data) are input into an image input unit 601. The image input unit 601 outputs the editing-subject image data to an image processing unit 602. Further, the image input unit 601 exchanges synchronization information with a. synchronization control unit 603.

For example, when the image input unit 601 outputs the editing-subject image data of a certain frame, the image input unit 601 outputs synchronization information for reading the display information of the frame from an information storage unit 604 to the synchronization control unit 603. In this case, in accordance with the synchronization information from the image input unit 601, the synchronization control unit 603 outputs an instruction (a read instruction) for reading, from the information storage unit 604, the display information of the frame (the display subject frame) output from the image input unit 601. The read instruction is output to a display mode setting unit 613, a performance information extraction unit 614, and a processing parameter extraction unit 615.

Note that a user operation (a read operation) for reading the display information of a certain frame from the information storage unit 604 may be executed on the editing display apparatus 102. In this case, the synchronization control unit 603 outputs an instruction (a read instruction) for reading the display information corresponding to the read operation. Further, the synchronization control unit 603 outputs synchronization information for displaying the frame corresponding to the read operation to the image input unit 601. The image input unit 601 then outputs the editing-subject image data of the frame corresponding to the user operation in accordance with the synchronization information from the synchronization control unit 603.

Identical information to the information recorded in the information storage unit 211 is recorded in the information storage unit 604. The information storage unit 604 may be either a storage unit built into the editing display apparatus 102 or a storage unit that can be attached to and detached from the editing display apparatus 102. In this embodiment, the information storage unit 211 (the USB memory) serves as the information storage unit 604.

The image processing unit 602 implements predetermined image processing on the editing-subject image data and outputs image data and so on obtained as a result of the predetermined image processing. The image processing unit 602 includes an IDT processing unit 605, an image adjustment unit 606, an RRT processing unit 608, and an ODT processing unit 609.

The IDT processing unit 605 implements IDT on the editing-subject image data. As a result, the editing-subject image data, which are image data in the unique color space of the imaging apparatus, are converted into ACES_RGB image data, which are image data in the ACES space. The IDT processing unit 605 then outputs the ACES_RGB image data to the image adjustment unit 606.

The image adjustment unit 606 implements main color grading processing corresponding to an instruction from the user (a user operation performed on the editing display apparatus 102) on the ACES_RGB image data output from the IDT processing unit 605. The main color grading processing is image processing performed during main color grading. The image adjustment 606 then outputs image data obtained as a result of the main color grading processing to the RRT processing unit 608.

More specifically, a monitor adjustment value conversion unit 607 determines the processing parameters in response to an instruction from the user, and sets the determined processing parameters in the image processing unit 602 (the image adjustment unit 606). The image adjustment unit 606 then implements main color grading processing using the set processing parameters on the ACES_RGB image data.

The RRT processing unit 608 implements RRT on the image data output from the image adjustment unit 606 and outputs image data obtained as a result of the RRT to the ODT processing unit 609.

The ODT processing unit 609 implements ODT processing and conversion processing based on SMPTE ST-2084 on the image data output from the RRT processing unit 608. As a result, image data corresponding to the unique color space of an LCD module 611 and having a grayscale characteristic conforming to SMPTE ST-2084 (a grayscale characteristic based on a human visual characteristic) are generated. Further, the ODT processing unit 609 generates a BL adjustment value so that an image based on the editing-subject image data is displayed favorably. The ODT processing unit 609 outputs image data obtained as a result of the ODT processing to the LCD module 611 and outputs the BL adjustment value to a BL adjustment unit 610. When the ODT-processed image data are input into the LCD module 611, the transmittance of a liquid crystal panel provided in the LCD module 611 is controlled in accordance with the ODT-processed image data.

The BL adjustment unit 610 generates a BL control signal in accordance with the BL adjustment value output from the ODT processing unit 609. The BL adjustment unit 610 then outputs the generated BL control signal to a BL driving unit 612. The BL driving unit 612 controls the emission brightness of a backlight module provided in the LCD module 611 in accordance with the BL control signal output from the BL adjustment unit 610.

Note that similarly to the image processing unit 202, mode information may be set in the image processing unit 602. Accordingly, processing taking account of the mode information may be performed by the image processing unit 602.

In this embodiment, the editing display apparatus 102 can perform display emulating the display on the on-set display apparatus 101. Hereafter, “display emulating the display on the on-set display apparatus 101” will be referred to as “emulative display”. Emulative display is display emulating the display displayed in the display mode of the on-set display apparatus 101 at the time of the provisional color grading processing. A method for realizing emulative display will be described below

When the read instruction is output from the synchronization control unit 603, the display information is obtained from the information storage unit 604 by the display mode setting unit 613, the performance information extraction unit 614, and the processing parameter extraction unit 615. The obtained display information indicates a past display mode of an image based on the editing-subject image data (specifically, the input image data of the on-set display apparatus 101). More specifically, the obtained display information indicates the display mode of the on-set display apparatus 101 at the time of the provisional color grading processing.

More specifically, in response to the read instruction, the display mode setting unit 613 reads the mode information (the information indicating the display anode and the display parameters) from the information storage unit 604. The display mode setting unit 613 then converts the read mode information into mode information corresponding to the editing display apparatus 102 and outputs the converted mode information to the monitor adjustment value conversion unit 607. The converted mode information is one of the pieces of information required to realize emulative display.

Here, a case in which a plurality of sets of mode information (information indicating each of a plurality of display modes, a plurality of display parameters, and so on) exist as the mode information corresponding to a single frame will be considered. In this case, the display mode setting unit 613 selects and uses one of the plurality of sets of mode information in response to a user operation performed on the editing display apparatus 102. By switching the selected set of mode information to another set of mode information, the display mode and display parameters reproduced by the emulative display can be switched. Further, the display mode setting unit 613 can select and use two or more sets of mode information. As a result, a plurality of emulative displays corresponding to the plurality of sets of mode information can be realized simultaneously.

The performance information extraction unit 614 reads the performance information from the information storage unit 604 in response to the read instruction. The performance information extraction unit 614 then generates a performance adjustment value, which serves as one of the pieces of information required to realize emulative display, from the read performance information, and outputs the generated performance adjustment value to the monitor adjustment value conversion unit 607. The performance adjustment value is a LUT for bridging a imp between the respective performances of the on-set display apparatus 101 and the editing display apparatus 102, for example.

The processing parameter extraction unit 615 reads the processing parameters from the information storage unit 604 in response to the read instruction. The processing parameter extraction unit 615 then adjusts the read processing parameters and outputs the adjusted processing parameters to the monitor adjustment value conversion unit 607. The adjusted processing parameters are one of the pieces of information required to realize emulative display. In the processing parameter extraction unit 615, processing for converting the read processing parameters into processing parameters corresponding to the editing display apparatus 102, for example, is executed as processing parameter adjustment.

The monitor adjustment value conversion unit 607 determines the processing parameters for realizing emulative display on the basis of the information output from the display mode setting unit 613, the performance information extraction unit 614, and the processing parameter extraction unit 615. The monitor adjustment value conversion unit 607 then sets the determined processing parameters in the image processing unit 602 (the image adjustment unit 606). As a result, display control for realizing emulative display is performed. In other words, display control for displaying an image based on the editing-subject image data on the LCD module 611 in the same display anode as the past display mode is performed.

Hence, in the editing display apparatus 102, display control for realizing emulative display is performed on the basis of the display information. As long as the display information is used, there are no particular limitations on the method for realizing emulative display.

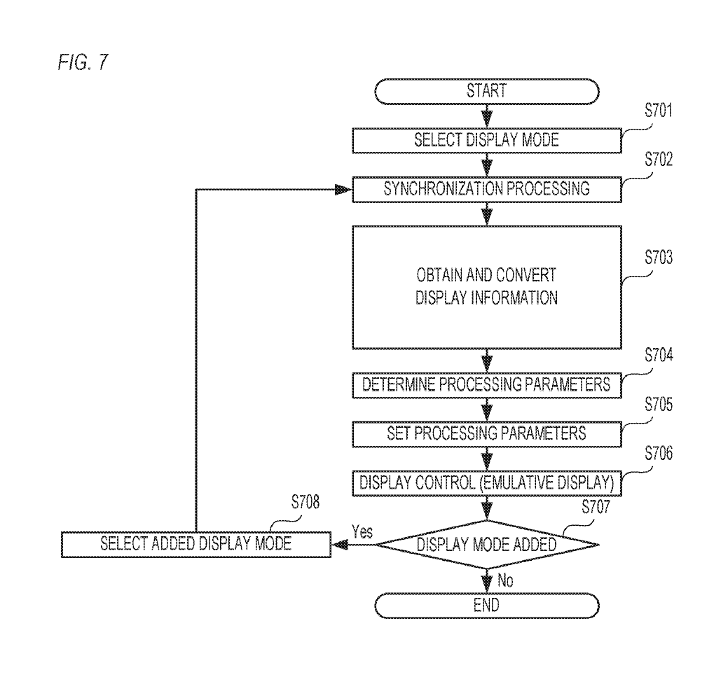

FIG. 7 is a flowchart showing an example of a processing flow of the editing display apparatus 102. The processing flow shown in FIG. 7 is started in response to an emulative display start operation executed on the editing display apparatus 102, for example. The emulative display start operation is a user operation for issuing an instruction to start emulative display.

First, in S701, the display mode setting unit 613 selects one of the plurality of display modes that can be selected by the on-set display apparatus 101 in response to an instruction from the user. In S701, for example, a list of the plurality of display modes is displayed and one of the plurality of display modes on the list is selected. Note that the processing of S701 may be performed after processing of S703. In this case, measures may be taken so that only the display modes related to the mode information indicated by the obtained display information are used as the display mode that can be selected by the display mode setting unit 613.

Next, in S702, the synchronization control unit 603 executes synchronization processing so that the display information is read from the information storage unit 604 in synchronization with output of the editing-subject image data from the image input unit 601. More specifically, the synchronization control unit 603 outputs a read instruction in response to the synchronization information from the image input unit 601.

Next, in S703, the display information corresponding to the display mode selected in S701 is obtained from the information storage unit 604 by the display mode setting unit 613, the performance information extraction unit 614, and the processing parameter extraction unit 615. Processing using the obtained display information is then executed by, the display mode setting unit 613, the performance information extraction unit 614, and the processing parameter extraction unit 615. The processing of the display mode setting unit 613, the processing of the performance information extraction unit 614, and the processing of the processing parameter extraction unit 615 are as described above.

When display information corresponding to the display mode selected in S701 does not exist, predetermined information is transmitted to the user. The processing then returns to S701. For example, an image (a text image, an icon, or the like) indicating that no display information exists is displayed on the screen of the editing display apparatus 102. The predetermined information may also be transmitted by voice.

Next, in S704, the monitor adjustment value conversion unit 607 determines the processing parameters for realizing emulative display on the basis of the results of the processing (the processing using the display information) performed in S703.

Next, in S705, the monitor adjustment value conversion unit 607 sets the processing parameters determined in S704 in the image processing unit 602 (the image adjustment unit 606).

Next, in S706, display control using the processing parameters determined in S705 is performed by the image processing unit 602, the BL adjustment unit 610, and the BL driving unit 612. As a result, emulative display corresponding to the display mode selected in S701 is realized.

In S707, the editing display apparatus 102 (for example, a control unit, not shown, provided in the editing display apparatus 102) determines whether or not a display mode addition operation has been performed on the editing display apparatus 102. The display mode addition operation is a user operation for adding a display mode in order to realize emulative display. When a display mode addition operation has been performed, the processing advances to S708, and when a display mode addition operation has not been performed, the processing flow is terminated.

In S708, the display mode setting unit 613 selects the added display mode in response to the display mode addition operation. The processing then returns to S702. As a result, additional emulative display of an image corresponding to the display mode selected in S708 is realized. In other words, a multiscreen display, in which an image corresponding to the display mode selected in S701 and an image corresponding to the display mode selected in S708 are displayed side by side, is displayed.

Note that a display mode switch operation may be performed instead of the display mode addition operation. The display mode switch operation is a user operation for switching the display mode for realizing the emulative display to another display mode. When a display mode switch operation is performed, the display on the editing display apparatus 102 is updated from emulative display of an image corresponding to the display mode selected in S701 to emulative display of an image corresponding to the display mode following the display mode switch operation.

According to this embodiment, as described above, a display emulating a display displayed in a past display mode can be realized easily by the simple method of recording display information indicating the used display mode in a storage unit and then reading the display information from the storage unit and using the read display information.

### Second Embodiment

A second embodiment of the present invention will now be described. In this embodiment, an example in which the image processing system is improved in user-friendliness will be described. Note that in the following description, similar features (configurations and processing) to the first embodiment have been omitted, while features that differ from the first embodiment are described in detail.

When clip display is performed, an outside brightness of the clip range is limited to a predetermined brightness. Therefore, while focusing on image regions limited to the predetermined brightness, the user uses the compression mode in order to finely adjust and check these image regions, and while focusing on image regions corresponding to the clip range, the user uses the clip mode in order to finely adjust and check these image regions. Hence, the image region on which the user focuses is dependent on the display mode.

In this embodiment, in accordance with the display control (display control for realizing emulative display) performed by the editing display apparatus 102, an image based on the editing-subject image data is displayed so that an image region that was focused on during past display in a past display mode can be distinguished from other image regions. More specifically, the image region that was focused on during the provisional color grading is differentiated from other image regions. In so doing, the user-friendliness of the image processing system can be improved. For example, the user can easily ascertain the image region that was focused on during the past display. In other words, the image region that was focused on, the purpose of the work, and so on can be imparted to a post-processing user with a high degree of precision. As a result, the work efficiency of the post-processing can be improved.

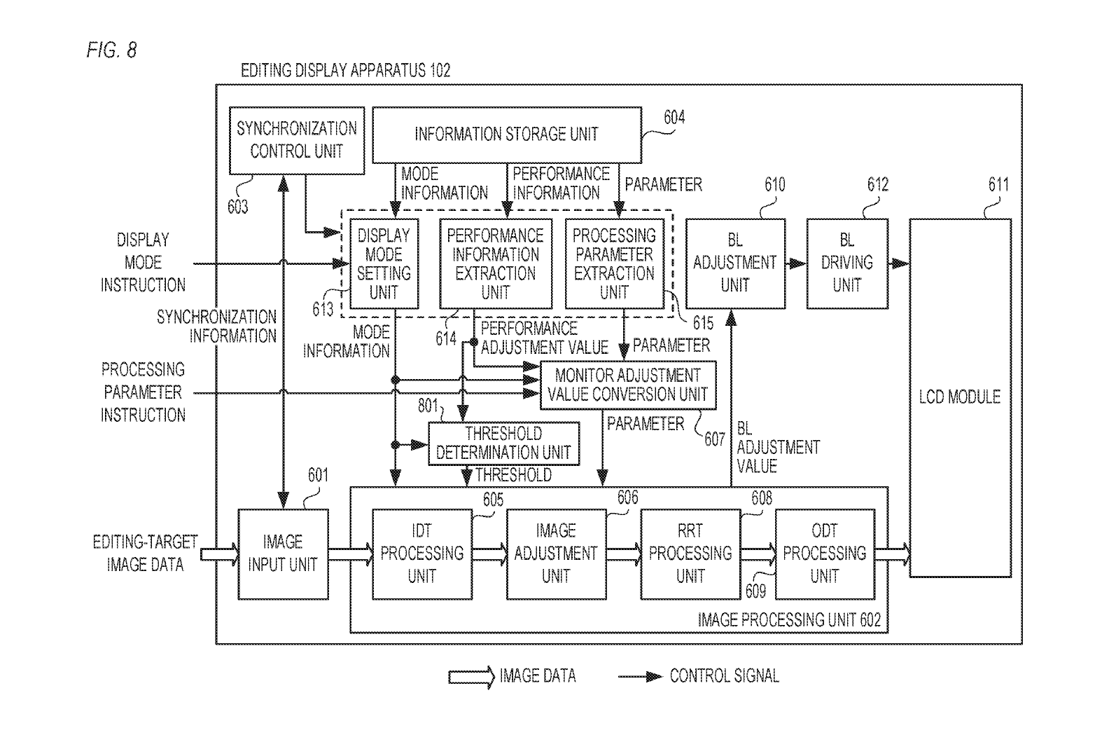

FIG. 8 is a block diagram showing an example configuration of the editing display apparatus 102 according to this embodiment. The editing display apparatus 102 according to this embodiment further includes a threshold determination unit 801. In FIG. 8, identical function units to those of the first embodiment (FIG. 6) have been allocated identical reference numerals to the first embodiment.

The threshold determination unit 801 determines a threshold for determining the image region that was focused on in the past. The threshold determination unit 801 then outputs the determined threshold to the image processing unit 602 (the image adjustment unit 606). In this embodiment, the threshold determination unit 801 obtains the converted mode information from the display mode setting unit 613 and obtains the performance adjustment value from the display mode setting unit 613. The threshold determination unit 801 then determines the threshold on the basis of the converted mode information and the performance adjustment value. A grayscale value corresponding to the upper brightness limit of the clip range, a grayscale value corresponding to a lower brightness limit of the clip range, or the like, for example, is determined as the threshold.

In this embodiment, the image adjustment unit 606 executes similar processing to the first embodiment. Note, however, that in this embodiment, the image adjustment unit 606 determines the image region that was focused on in the past on the basis of the threshold from the threshold determination unit 801. The image adjustment unit 606 then reworks and outputs the image data subjected to the main color grading processing so that the image region that was focused on is displayed identifiably. Here, a case in which a grayscale value corresponding to the upper brightness limit of the clip range is determined as the threshold will be considered. In this case, an image range in which the grayscale value following the main color grading processing is larger than the threshold is detected, and the image data subjected to the main color grading processing are reworked so that the detected image range is displayed identifiably. Next, a case in which a grayscale value corresponding to the lower brightness limit of the clip range is determined as the threshold will be considered. In this case, an image range in which the grayscale value following the main color grading processing is smaller than the threshold is detected, and the image data subjected to the main color grading processing are reworked so that the detected image range is displayed identifiably.

Note that the method of displaying the image region that was focused on in the past identifiably is not limited to the method described above. As long as the image region that was focused on in the past can be distinguished from the other image regions, any method may be used. For example, a method of emphasizing the contours of the image region that was focused on, a method of causing the image region that was focused on to flash, a method of changing the color of the image region that was focused on, a method of changing the brightness of the image region that was focused on, and so on may be employed as a method of changing the display of the image region that was focused on. Further, the display of an image region other than the image region that was focused on may be changed. An image region in which the grayscale value varied as a result of the main color grading processing may be detected and displayed identifiably.

According to this embodiment, as described above, display control for displaying an image is performed so that an image region that was focused on during past display in a past display mode can be distinguished from other image regions. In so doing, the user-friendliness of the image processing system can be improved. Note that transmission processing for transmitting the display information indicating the past display mode to the user may also be implemented. Likewise with this configuration, the user-friendliness of the image processing system can be improved. For example, the user can easily ascertain the past display mode. As the processing for transmitting the display information, for example, a graphic image representing the display information may be displayed, a voice expressing the display information may be output, and so on.

### Third Embodiment

A third embodiment of the present invention will now be described. Note that in the following description, similar features (configurations and processing) to the first embodiment have been omitted, while features that differ from the first embodiment are described in detail. In this embodiment, an example in which different display modes from those of the first and second embodiments are used will be described. More specifically, an example in which a display mode for performing boost display is used will be described. Note that in the example described below, either simple compression display or clip display is used together with boost display, but simple compression display and clip display do not have to be performed.

In boost display, a partial image region is displayed at a set brightness and the other image regions are displayed at a reference brightness. More specifically, in boost display, the set brightness is used as an upper limit value of the display brightness of the partial image region, and the reference brightness is used as an upper limit value of the display brightness in the other image regions. In the on-set display apparatus, limitations on the power supply may make it impossible to display an entire image at a high brightness. By limiting the high brightness to a partial image region, however, the high brightness can be displayed even by the on-set display apparatus.

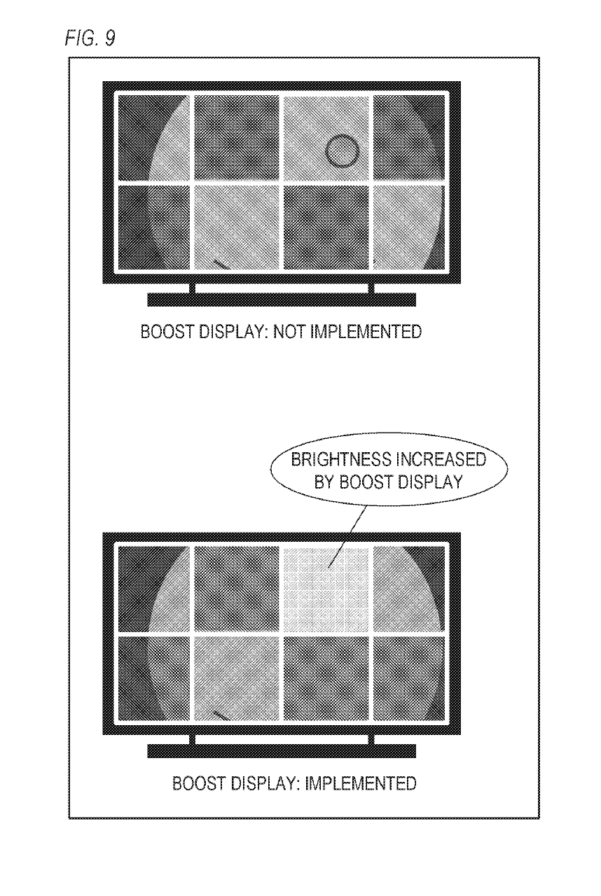

FIG. 9 shows an example of boost display. In the example shown in FIG. 9, the brightness of an image region in row 1 column 3 is increased by boost display.

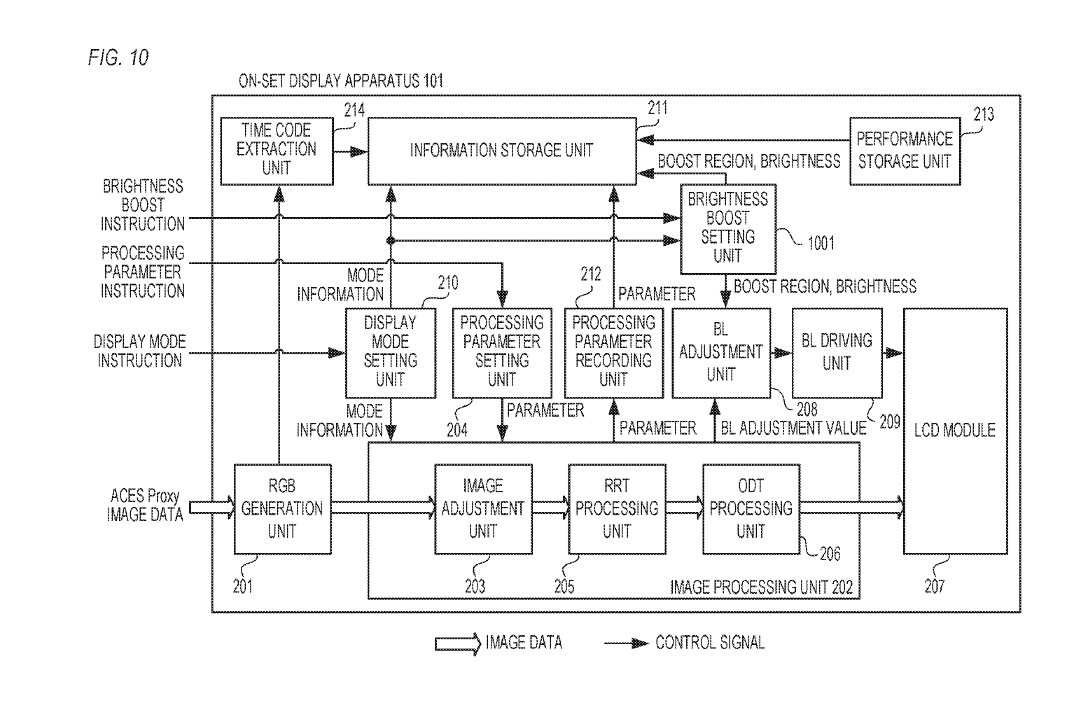

FIG. 10 is a block diagram showing an example configuration of the on-set display apparatus 101 according to this embodiment. The on-set display apparatus 101 according to this embodiment further includes a brightness boost setting unit 1001. In FIG. 10, identical function units to those of the first embodiment (FIG. 2) have been allocated identical reference numerals to the first embodiment.

The brightness boost setting unit 1001 determines whether or not to execute boost display in response to an instruction from the user (an instruction specifying whether or not to execute boost display). When boost display is to be executed, the brightness boost setting unit 1001 determines a boost region in response to an instruction from the user (an instruction specifying the boost region). The boost region is the image region to be displayed at the set brightness. Further, the brightness boost setting unit 1001 obtains the currently set mode information from the display mode setting unit 210. The brightness boost setting unit 1001 then determines the brightness of the boost region on the basis of the determined boost region and the obtained mode information. For example, the brightness of the boost region is determined so that the state of the power supply of the on-set display apparatus 101 satisfies limitations. The brightness boost setting unit 1001 sets the determined boost region and the determined brightness in the BL adjustment unit 208. Further, the brightness boost setting unit 1001 records information relating to the current state of boost display in the information storage unit 211 at a predetermined timing as a part of the display information. For example, information indicating whether or not boost display has been executed, the boost region, the brightness of the boost region, and so on is recorded in the information storage unit 211.

There are no particular limitations on the method for determining whether or not to execute boost display, the method for determining the boost region, the method for determining the brightness of the boost region, and so on. For example, display control may be performed by the on-set display apparatus 101 so that boost display is executed at all times. The boost region and the brightness thereof may be determined automatically on the basis of a brightness distribution of the image, the environment in which the on-set display apparatus 101 is used, and so on. The brightness of the boost region may be determined only in response to an instruction from the user.

In this embodiment, the BL adjustment unit 208 performs similar processing to the first embodiment. Note, however, that in this embodiment, when boost display is executed, the BL adjustment unit 208 generates the BL control signal on the basis of the BL adjustment value from the ODT processing unit 206 and the boost information (the boost region and the brightness thereof) set by the brightness boost setting unit 1001. More specifically, the BL adjustment unit 208 generates the BL control signal so that the display brightness in the set boost region is controlled to a brightness corresponding to the set brightness. As a result, boost display is realized.

There are no particular limitations on the method for realizing boost display. For example, boost display may be realized by correcting the image data on the basis of the set boost region and the set brightness. Boost display may also be realized by having the BL driving unit 209 correct the BL control signal on the basis of the set boost region and the set brightness.

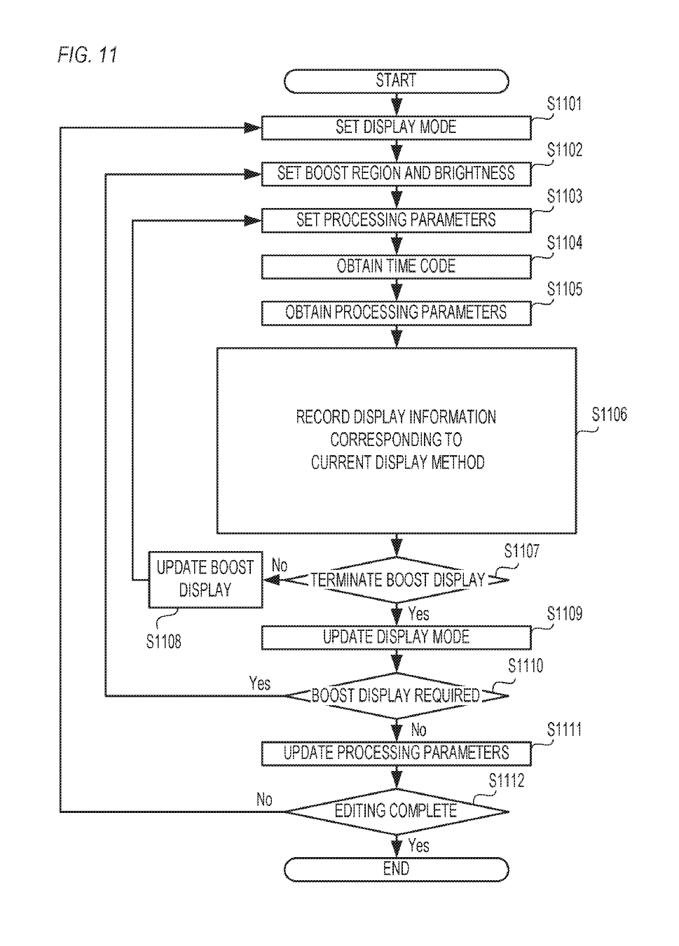

FIG. 11 is a flowchart showing an example of a processing flow of the on-set display apparatus 101 according to this embodiment. The processing flow shown in FIG. 11 is started in response to the provisional color grading start operation executed on the on-set display apparatus 101, for example. A processing flow employed in a case where boost display is executed will be described below. The processing flow employed in a case where boost display is not executed is identical to that of the first embodiment (FIG. 4).

First, in S1101, the display mode setting unit 210 selects one of the plurality of display modes in response to an instruction from the user. The mode information relating to the selected display mode is set in the image processing unit 202 (the ODT processing unit 206) and the brightness boost setting unit 1001.

Next, in S1102, the brightness boost setting unit 1001 determines the boost region in response to an instruction from the user, and determines the brightness of the boost region on the basis of the determined boost region and the mode information set in S1101. The brightness boost setting unit 1001 then sets the determined boost region and the determined brightness in the 131, adjustment unit 208.

Next, in S1103, the processing parameter setting unit 204 determines the processing parameters in response to an instruction from the user, and sets the determined processing parameters in the image processing unit 202 (the image adjustment unit 203). As a result, processed image data are generated using the set processing parameters, and an image based on the processed image data is displayed in the set display mode. Processing parameters corresponding to the entire image may be determined, but in this embodiment, the processing parameters are determined in relation to the boost region determined in S1102.

Next, in S1104, the time code extraction unit 214 extracts the time code of the image data (the frame) serving as the current processing subject from the additional information.

In S1105, the processing parameter recording unit 212 obtains the currently set processing parameters from the image processing unit 202.

Next, in S1106, the display information corresponding to the current display mode is recorded in the information storage unit 211. More specifically, the display mode setting unit 210 records the currently set mode information in the information storage unit 211 as a part of the display information corresponding to the current display mode, the processing parameter recording unit 212 records the processing parameters obtained in S1105 in the information storage unit 211 as a part of the display information corresponding to the current display mode, the performance storage unit 213 records the performance information in the information storage unit 211 as a part of the display information corresponding to the current display mode, the time code extraction unit 214 records the time code extracted in S1104 in the information storage unit 211 as a part of the display information corresponding to the current display mode, and the brightness boost setting unit 1001 records the information relating to the current state of boost display in the information storage unit 211 as a part of the display information corresponding to the current display mode.

In S1107, the on-set display apparatus 101 (for example, the control unit, not shown, provided in the on-set display apparatus 101) determines whether or not boost display on the processing subject frame is to be terminated. For example, when a user operation for issuing an instruction to terminate boost display is performed, it is determined that “boost display on the processing subject frame is to be terminated”. When a user operation for issuing an instruction to change the boost region, add a boost region, and so on is performed, it is determined that “boost display on the processing subject frame is not to be terminated”. When boost display is not to be terminated, the processing advances to S1108, and when boost display is to be terminated, the processing advances to S1109.

In S1108, the brightness boost setting unit 1001 determines the boost region anew in response to the instruction from the user, and determines the brightness of the newly determined boost region on the basis of the newly determined boost region and the currently set mode information. The brightness boost setting unit 1001 then sets the newly determined boost region and the determined brightness (the brightness of the newly determined boost region) in the BL adjustment unit 208. As a result, the boost display is updated. The processing then returns to S1103. By executing the processing of S1103 to S1107 anew, display information corresponding to the newly determined boost region is recorded in the information storage unit 211. Here, the “newly determined boost region” denotes a “changed boost region”, an “added boost region”, and so on. Hence, according to this processing flow, the display information is recorded in the information storage unit 211 in response to variation in the set boost region. As noted in the first embodiment, there are no particular limitations on the timing at which to record the display information.

In S1109, the display mode setting unit 210 selects a changed display mode in response to the display anode change instruction, and sets the mode information relating to the selected display mode in the image processing unit 202 (the ODT processing unit 206). As a result, the set mode information is updated and the display is updated.

Next, in S1110, the on-set display apparatus 101 (for example, the control unit, not shown, provided in the on-set display apparatus 101) determines whether or not boost display corresponding to the changed display mode is to be executed. For example, when a user operation for issuing an instruction to execute boost display is performed, it is determined that “boost display corresponding to the changed display mode is to be executed”. When a user operation for issuing an instruction not to execute boost display is performed, it is determined that “boost display corresponding to the changed display mode is not to be executed”. When boost display is to be executed, the processing returns to S1102, and When boost display is not to be executed, the processing advances to S1111.

In S1111, the processing parameter setting unit 204 determines (modifies) the processing parameters in response to an instruction from the user and sets the determined processing parameters in the image processing unit 202 (the image adjustment unit 203). As a result, the set processing parameters are updated and the display is updated. The processing then advances to S1112. Note that the processing of S1109 to S1111 is executed only when a display mode change operation is performed.

In S1112, the on-set display apparatus 101 (for example, the control unit, not shown, provided in the on-set display apparatus 101) determines whether or not a provisional color grading termination operation has been performed on the on-set display apparatus 101. When a provisional color grading termination operation has not been performed, the processing returns to S1101, and when a provisional color grading termination operation has been performed, the processing flow is terminated,

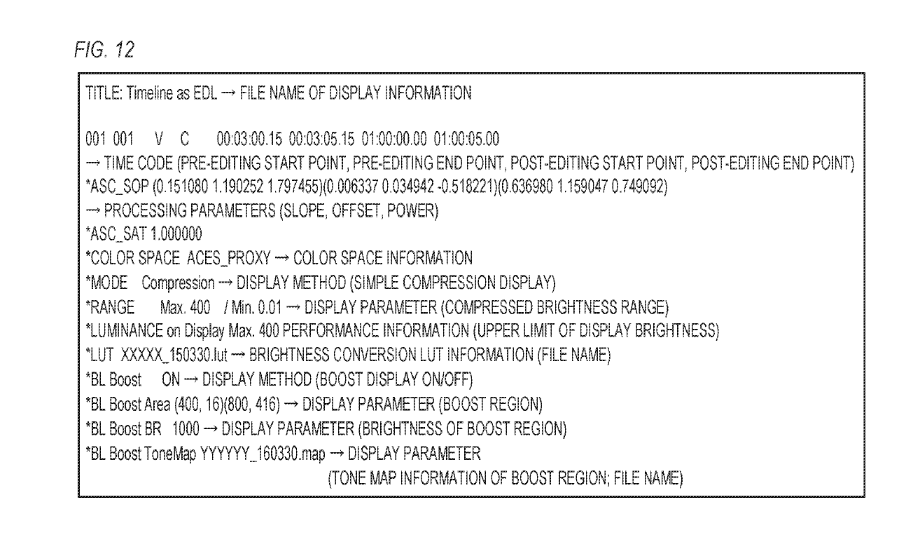

FIG. 12 shows an example of the display information according to this embodiment. FIG. 12 shows an example of a case in which the parameters defined by the ASC CDL are used as the processing parameters. FIG. 12 also shows an example of a case in which a data file of the display information is generated by adding other information to the data file of the processing parameters. Note that the display information shown in FIG. 12 is merely an example, and the display information is not limited to the information shown in FIG. 12.

The display information shown in FIG. 12 includes information relating to the state of boost display in addition to the information of the first embodiment (FIG. 5). More specifically, the display information shown in FIG. 12 includes information indicating whether or not boost display has been executed as a part of the information indicating the display mode. In the display information shown in FIG. 12, information indicating the boost region and information indicating the brightness of the boost region are included as a part of the display parameters of the boost display. Furthermore, in the display information shown in FIG. 12, tone map information relating to the boost region is included as a part of the display parameters of the boost display. The tone map information of the boost region is information indicating a conversion characteristic of the grayscale values in the boost region.

In this embodiment, a plurality of image regions can be used as boost regions. When a plurality of boost regions are used, a plurality of sets of boost information (combinations of boost regions and brightnesses) corresponding respectively to the plurality of boost regions are described in the display information. Further, when a plurality of boost regions are used, pluralities of processing parameters corresponding respectively to the plurality of boost regions can be set individually. When pluralities of processing parameters corresponding respectively to the plurality of boost regions are set, the pluralities of processing parameters are described in the display information.

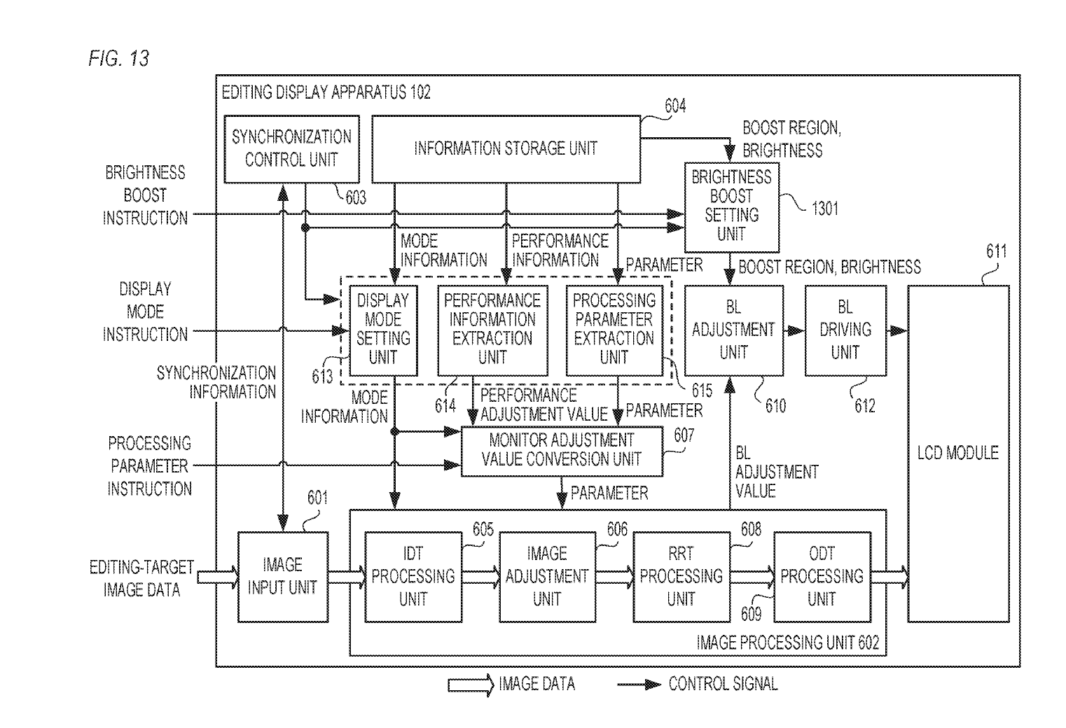

FIG. 13 is a block diagram showing an example configuration of the editing display apparatus 102 according to this embodiment. The editing display apparatus 102 according to this embodiment further includes a brightness boost setting unit 1301. In FIG. 13, identical function units to those of the first embodiment (FIG. 6) have been allocated identical reference numerals to the first embodiment. In the editing display apparatus 102, processing described below is executed additionally during emulative display.

The read instruction from the synchronization control unit 603 is also input into the brightness boost setting unit 1301. In response to the read instruction, the brightness boost setting unit 1301 reads the information relating to the state of boost display from the information storage unit 604. For example, the boost information (the boost region and the brightness of the boost region) is read. The brightness boost setting unit 1301 then sets the read boost information in the BL adjustment unit 610. As a result, the BL control signal is generated by the BL adjustment unit 610 on the basis of the BL adjustment value from the ODT processing unit 609 and the boost information set by the brightness boost setting unit 1301. More specifically, the BL control signal is generated by the BL adjustment unit 610 so that the display brightness in the set boost region is controlled to a brightness corresponding to the set brightness. As a result, emulative display is realized in the set boost region.

Here, a case in which a plurality of boost regions exist as the boost regions corresponding to a single frame will be considered. In other words, a case in which a plurality of image regions were used as boost regions in a past display corresponding to the single frame will be considered. In this case, the brightness boost setting unit 1301 selects and uses one of the plurality of boost regions used in the past in response to a user operation performed on the editing display apparatus 102. By switching the selected boost region to another boost region, the image region (the boost region) in which emulative display is realized can be switched. The brightness boost setting unit 1301 can also select and use two or more boost regions. For example, the brightness boost setting unit 1301 can select and use two or more boost regions having identical mode information. As a result, emulative display can be realized simultaneously in each of the plurality of boost regions.

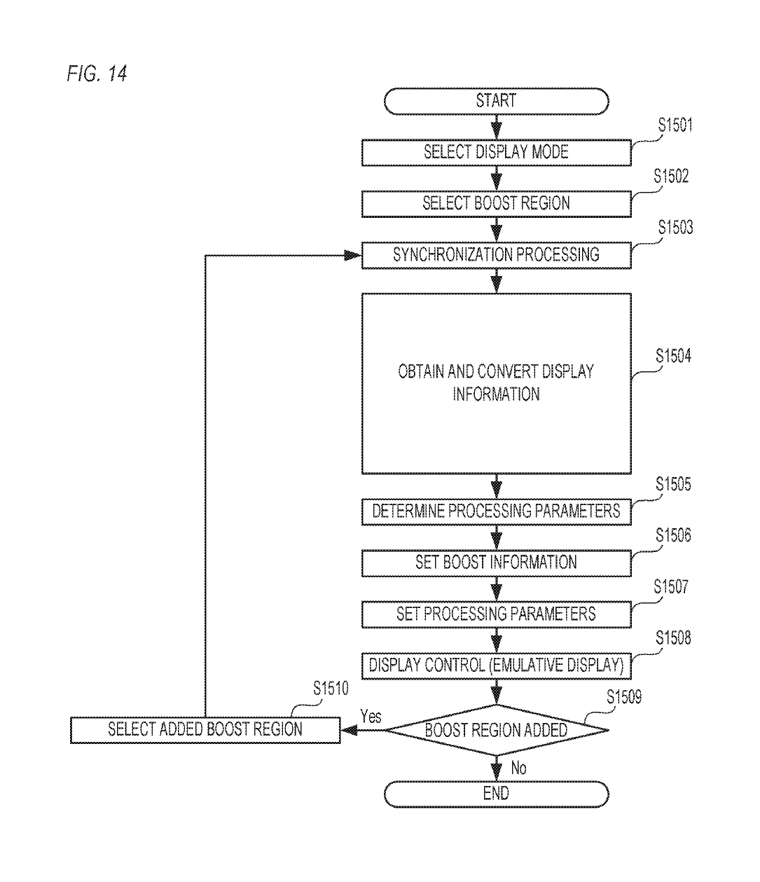

FIG. 14 is a flowchart showing an example of a processing flow of the editing display apparatus 102 according to this embodiment. The processing flow shown in FIG. 14 is started in response to an emulative display start operation executed on the editing display apparatus 102, for example. The emulative display start operation is a user operation for issuing an instruction to start emulative display.

First, in S1401, the display mode setting unit 613 selects one of the plurality of display modes that can be selected by the on-set display apparatus 101 in response to an instruction from the user.

Next, in S1402, the brightness boost setting unit 1301 selects one of the plurality of boost regions that can be selected by the on-set display apparatus 101 in response to an instruction from the user. In S1402, for example, a list of the plurality of boost regions is displayed and one of the plurality of boost regions on the list is selected. Note that the processing of S1402 may be performed after processing of S1404. In this case, measures may be taken so that only the boost regions indicated by the obtained display information are used as the boost regions that can be selected by the brightness boost setting unit 1301.

Next, in S1403, the synchronization control unit 603 executes synchronization processing so that the display information is read from the information storage unit 604 in synchronization with output of the editing-subject image data from the image input unit 601. More specifically, the synchronization control unit 603 outputs a read instruction in response to the synchronization information from the image input unit 601.

Next, in S1404, the display information is obtained from the information storage unit 604 by the display mode setting unit 613, the performance information extraction unit 614, the processing parameter extraction unit 615, and the brightness boost setting unit 1301. Here, display information corresponding to the display mode selected in S1401 and the boost region selected in S1402 is obtained from the information storage unit 604. Then, similarly to the first embodiment, processing using the obtained display information is executed by the display mode setting unit 613, the performance information extraction unit 614, and the processing parameter extraction unit 615.

When display information corresponding to the display mode selected in S1401 and the boost region selected in S1402 does not exist, predetermined information is transmitted to the user. The processing then returns to S1401. For example, an image (a text image, an icon, or the like) indicating that no display information exists is displayed on the screen of the editing display apparatus 102. The predetermined information may also be transmitted by voice.

Next, in S1405, the monitor adjustment value conversion unit 607 determines the processing parameters for realizing emulative display on the basis of the results of the processing (the processing using the display information) performed in S1404,

Next, in S1406, the brightness boost setting unit 1301 sets the boost information (the boost region and the brightness of the boost region) read in S1404 in the 131, adjustment unit 610.

Next, in S1407, the monitor adjustment value conversion unit 607 sets the processing parameters determined in S1405 in the image processing unit 602 (the image adjustment unit 606).

Next, in S1408, display control using the processing parameters determined in S1405 and the boost information read in S1404 is performed by the image processing unit 602, the BL adjustment unit 610, and the BL driving unit 612. As a result, emulative display corresponding to the display mode selected in S1401 is realized in the boost region selected in S1402. Note that in S1408, other information (the tone map information of the boost region and so on) for controlling the display brightness may be used additionally.

Next, in S1409, the editing display apparatus 102 (for example, the control unit, not shown, provided in the editing display apparatus 102) determines whether or not a boost region addition operation has been performed on the editing display apparatus 102. The boost region addition operation is a user operation for adding an image region (a boost region) in which emulative display is to be realized. When a boost region addition operation has been performed, the processing advances to S1410, and when a boost region addition operation has not been performed, the processing flow is terminated.

In S1410, the brightness boost setting unit 1301 selects the added boost region in response to the boost region addition operation. The processing then returns to S1403. As a result, emulative display is realized additionally in the boost region selected in S1410. In other words, emulative displays are displayed side by side in the boost region selected in S1402 and the boost region selected in S1410.

Note that a boost region switch operation may be performed instead of the boost region addition operation. The boost region switch operation is a user operation for switching the boost region in which to realize emulative display to another boost region. When a boost region switch operation is performed, the display on the editing display apparatus 102 is updated from emulative display in the boost region selected in S1401 to emulative display in the boost region following the switch performed in response to the boost region switch operation.

According to this embodiment, as described above, similar processing to the first embodiment is performed while taking account of the boost display. As a result, emulative display emulating a past boost display can be realized easily by a simple method.

### Fourth Embodiment

A fourth embodiment of the present invention will now be described. In the first to third embodiments, examples in which two display apparatuses (the on-set display apparatus and the editing display apparatus) are used were described. In this embodiment, an example in which a single display apparatus is used will be described. Further, in this embodiment, an example in which a different display mode from those of the first to third embodiments is used will be described. More specifically, an example in which a display mode for performing 131, control display is used will be described. BL control display is display control using a display unit (an LCD module) having a light-emitting unit (a backlight unit) and a display panel (a liquid crystal panel) that displays images by transmitting light from the light-emitting unit. More specifically, in BL control display, an image is displayed by controlling the emission brightness of the light-emitting unit to a set emission brightness.

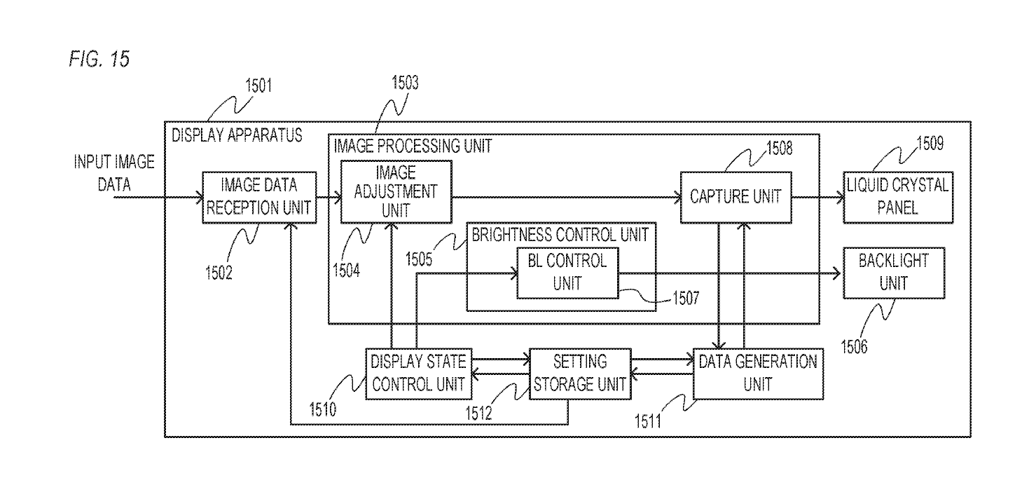

FIG. 15 is a block diagram showing an example configuration of a display apparatus 1501 according to this embodiment.

An image data reception unit 1502 receives image data (input image data) from the exterior of the display apparatus 1501. In this embodiment, the input image data are moving image data. The image data reception unit 1502 can also receive capture image data from a setting storage unit 1512. The capture image data are still image data corresponding to a single frame of the input image data. The image data reception unit 1502 determines the data format of the received image data, and converts the data format of the received image data into a data format that can be processed in the interior of the display apparatus 1501. The image data reception unit 1502 then outputs image data obtained as a result of the data format conversion to an image processing unit 1503.

The image processing unit 1503 includes an image adjustment unit 1504, a brightness control unit 1505, and a capture unit 1508. The image data output from the image data reception unit 1502 are input into the image adjustment unit 1504.

The image adjustment unit 1504 implements predetermined image processing on the image data output from the image data reception unit 1502. The predetermined image processing is image processing executed during color grading, for example. More specifically, the predetermined image processing includes color matrix conversion, CDL adjustment, and so on. Color matrix conversion is image processing for converting respective pixel values of the image data output from the image data reception unit 1502 from YCbCr values to RGB values. CDL adjustment is image processing using the parameters defined by the ASC CDL. The image adjustment unit 1504 outputs image data obtained as a result of the predetermined image processing to the capture unit 1508. The image adjustment unit 1504 can also omit the predetermined image processing and output the image data output from the image data reception unit 1502 as is to the capture unit 1508 (through processing).

Further, the image adjustment unit 1504 receives a notification relating to whether or not capture reproduction is underway from the display state control unit 1510. Capture reproduction is processing for reading the capture image data from the setting storage unit 1512 and displaying a still image based on the read capture image data. The image adjustment unit 1504 determines whether or not to execute the predetermined image processing in accordance with whether or not capture reproduction is underway. This will be described in detail below.

The brightness control unit 1505 includes a BL control unit 1507. A display brightness is transmitted from the display state control unit 1510 to the BL control unit 1507. The BL control unit 1507 generates a control value relating to the emission brightness of a backlight unit 1506 in accordance with the display brightness transmitted from the display state control unit 1510. For example, the BL control unit 1507 generates the control value so that white is displayed at the display brightness transmitted from the display state control unit 1510. More specifically, when a display brightness of 500 cd/m² is transmitted to the BL control unit 1507 from the display state control unit 1510, the BL control unit 1507 generates the control value so that white is displayed at a display brightness of 500 cd/m². The brightness control unit 1505 then outputs the generated control value to the backlight unit 1506.

The backlight unit 1506 emits light at an emission brightness corresponding to the control value output from the BL control unit 1507. The emission brightness of the backlight unit 1506 can be changed by, for example, changing the pulse width of a pulse signal supplied to a light-emitting element of the backlight unit 1506, the pulse amplitude of the pulse signal, or both thereof A light-emitting diode, an organic EL element, a cold-cathode tube, a plasma element, or the like can be used as the light-emitting element of the backlight unit 1506. The pulse width, the pulse amplitude, or both thereof, for example, can be used as the control value. The “emission brightness transmitted from the display state control unit 1510” may also be referred to as a “set value of the emission brightness of the backlight unit 1506”. Further, “processing for outputting the control value to the backlight unit 1506” may also be referred to as “processing for controlling the emission brightness of the backlight unit 1506”.

The capture unit 1508 outputs the image data output from the image adjustment unit 1504 as is to the liquid crystal panel 1509. Further, the capture unit 1508 receives a notification relating to whether or not capture processing is to be executed from a data generation unit 1511. When a notification indicating that the capture processing is to be executed is not received, the capture unit 1508 does not execute the capture processing, and when a notification indicating that the capture processing is to be executed is received, the capture unit 1508 executes the capture processing. The capture processing is processing for generating a frame currently displayed by the display apparatus 1501 (the liquid crystal panel 1509), among a plurality of frames constituting a moving image based on the input image data, as capture image data, which are still image data. The capture image data are generated using the image data output from the image adjustment unit 1504. The capture unit 1508 outputs the generated capture image data to the data generation unit 1511.

The liquid crystal panel 1509 displays an image by transmitting the light from the backlight unit 1506. In this embodiment, the transmittance of the liquid crystal panel 1509 is controlled in accordance with the image data output to the liquid crystal panel 1509 from the capture unit 1508.

The display state control unit 1510 transmits the display brightness to the BL control unit 1507. For example, the display state control unit 1510 reads the display brightness from the setting storage unit 1512 and transmits the read display brightness to the BL control unit 1507. The display state control unit 1510 is also capable of transmitting a display brightness specified by the user to the BL control unit 1507. The user can issue an instruction to change the display brightness on the display apparatus 1501. When an instruction to change the display brightness is issued, the display state control unit 1510 transmits the changed display brightness to the BL control unit 1507.

The display state control unit 1510 also outputs a notification relating to whether or not capture reproduction is underway to the image adjustment unit 1504. For example, the display state control unit 1510 notifies the image adjustment unit 1504 of the start of capture reproduction in response to a capture reproduction start operation (a user operation for issuing an instruction to start capture reproduction) performed on the display apparatus 1501. Further, the display state control unit 1510 notifies the image adjustment unit 1504 of the end of capture reproduction in response to a capture reproduction termination operation (a user operation for issuing an instruction to terminate capture reproduction) performed on the display apparatus 1501. In this case, the image adjustment unit 1504 determines a period extending from the capture reproduction start operation to the capture reproduction termination operation to be a period in which capture reproduction is underway and determines other periods to be periods in which capture reproduction is not underway.

The data generation unit 1511 outputs a notification relating to whether or not the capture processing is to be executed to the capture unit 1508. For example, the data generation unit 1511 outputs a notification indicating that the capture processing is to be executed to the capture unit 1508 in response to a capture execution operation (a user operation for issuing an instruction to execute the capture processing) performed on the display apparatus 1501.

Furthermore, the data generation unit 1511 obtains the capture image data output from the capture unit 1508. Having obtained the capture image data, the data generation unit 1511 obtains information indicating the currently set display brightness from the setting storage unit 1512. The data generation unit 1511 then associates the obtained capture image data with the obtained display brightness (the information indicating the display brightness) and records the result in the setting storage unit 1512. Note that it is possible to determine from the information indicating the display brightness that the display mode corresponds to BL control display. Hence, the “information indicating the display brightness” may also be referred to as “display information indicating the display mode”. Needless to mention, the “information indicating the display brightness” may also be referred to as “information relating to a parameter indicating the display brightness”, “information relating to a display parameter used in BL control display”, and so on.

The setting storage unit 1512 is a storage unit such as a nonvolatile memory. The setting storage unit 1512 obtains the information indicating the currently set display brightness (setting information) from the display state control unit 1510 and stores the obtained setting information. Further, the setting storage unit 1512 obtains the information output from the data generation unit 1511 (information including the mutually associated capture image data and display brightness; capture data) and stores the obtained capture data. The capture data are stored separately to the setting information. Note that the setting storage unit 1512 may be a separate apparatus (a storage apparatus such as a USB memory, for example) to the display apparatus 1501.

Processing executed by the respective function units during the capture processing will now be described. It is assumed here that a moving image based on the input image data is displayed by the display apparatus 1501. It is also assumed that the predetermined image processing has been executed in the image adjustment unit 1504.

The data generation unit 1511 outputs a notification indicating that the capture processing is to be executed (a capture execution notification) to the capture unit 1508. The capture unit 1508 generates capture image data of the frame displayed at the reception timing of the capture execution notification on the basis of the image data output from the image adjustment unit 1504. The capture unit 1508 then outputs the generated capture image data to the data generation unit 1511. Note that there are no particular limitations on the data format of the capture image data. BMP image data, JPEG image data, PNG image data, and so on, for example, are generated as the capture image data.

The data generation unit 1511, having obtained the capture image data from the capture unit 1508, obtains information indicating the currently set display brightness from the setting storage unit 1512. The data generation unit 1511 then associates the obtained capture image data with the obtained display brightness (the information indicating the display brightness) and records the result in the setting storage unit 1512. For example, when the capture image data are JPEG image data, the information indicating the display brightness is described as metadata in the MakerNote of the Exif (Exchange image file format) included in the capture image data. More specifically, when the set display brightness is 500 cd/m², “500” is described as the metadata. As a result, capture data including the mutually associated capture image data and display brightness are generated.

Note that as long as the information indicating the display brightness is information indicating a set value of the emission brightness of the backlight unit 1506, a set value of the display brightness, or the like, there are no particular limitations on the method of expressing the information indicating the display brightness. There are also no particular limitations on the method of generating the capture data. For example, data describing a save path of the capture image data and the information indicating the display brightness may be generated as separate data to the capture image data. In this case, a combination of the capture image data and the separate data is used as the capture data.

Processing executed by the respective function units during capture reproduction will now be described.

The display state control unit 1510 reads the display brightness associated with the reproduction subject capture image data from the setting storage unit 1512. The display state control unit 1510 then transmits the read display brightness to the BL control unit 1507. When the capture data are capture image data including the information indicating the display brightness as metadata, the display state control unit 1510 reads the reproduction subject capture data from the setting storage unit 1512. Next, the display state control unit 1510 obtains the display brightness information (the information indicating the display brightness) included in the read capture data by analyzing the read capture data. The display state control unit 1510 then transmits the obtained display brightness information to the BL control unit 1507.

Further, the display state control unit 1510 issues an instruction to the setting storage unit 1512 to output the reproduction subject capture image data to the image data reception unit 1502. In response to this instruction from the display state control unit 1510, the setting storage unit 1512 outputs the reproduction subject capture image data to the image data reception unit 1502. Further, the display state control unit 1510 notifies the image adjustment unit 1504 that capture reproduction is underway.

The image data reception unit 1502, having obtained the reproduction subject capture image data from the setting storage unit 1512, converts the data format of the obtained capture image data into a data format that can be processed in the interior of the display apparatus 1501. The image data reception unit 1502 then outputs image data obtained as a result of the data formal conversion to the image processing unit 1503.

The image adjustment unit 1504 obtains a notification indicating that capture reproduction is underway from the display state control unit 1510, and in accordance with the notification determines that capture reproduction is underway. When capture reproduction is underway, the image adjustment unit 1504 executes through processing. In other words, the image adjustment unit 1504 omits the predetermined image processing and outputs identical image data to the image data output from the image data reception unit 1502 to the capture unit 1508.

The reason for executing through processing will now be explained. In this embodiment, the capture image data are generated on the basis of the image data obtained as a result of the predetermined image processing. Accordingly, the predetermined image processing is already reflected in the capture image data recorded in the setting storage unit 1512. Hence, if the image adjustment unit 1504 executes the predetermined image processing during capture reproduction, image data subjected to the predetermined image processing twice are output from the image adjustment unit 1504. Since this is undesirable, through processing is executed during capture reproduction. Note that the information relating to the set display brightness is not used in the predetermined image processing, and therefore the set display brightness is not reflected in the capture image data recorded in the setting storage unit 1512.

The BL control unit 1507 controls the emission brightness of the backlight unit 1506 in accordance with the display brightness (the display brightness associated with the reproduction subject capture image data) transmitted from the display state control unit 1510. As a result, an image based on the capture image data is displayed in a display mode resembling the display mode at the time of the capture processing.

Note that during capture reproduction, the user may be asked whether or not the emission brightness of the backlight unit 1506 is to be controlled in accordance with the display brightness associated with the reproduction subject capture image data and so on. For example, a message such as The display brightness settings used during capture processing and capture reproduction are different. Do you wish to change the setting to the display brightness used during capture processing?” may be displayed, and in accordance with an instruction issued by the user in response to the message, the processing may be executed after being switched. More specifically, when an instruction to change the setting to the display brightness used during capture processing is issued, the emission brightness of the backlight unit 1506 is controlled in accordance with the display brightness associated with the reproduction subject capture image data, and when an instruction not to change the setting to the display brightness used during capture processing is issued, the emission brightness of the backlight unit 1506 is controlled in accordance with the currently set display brightness. The “currently set display brightness” is the “display brightness prior to change to the display brightness associated with the reproduction subject capture image data”.

According to this embodiment, a display emulating a display displayed in a past display mode can be realized easily by the simple method of associating the capture image data and the display brightness with each other, recording the result in the storage unit, and using the recorded display brightness when the capture image data are reproduced. More specifically, during reproduction of the capture image data, BL control display, in which the emission brightness of the backlight unit is controlled to the same brightness as the brightness thereof during generation of the capture image data, can be implemented easily.

### Fifth Embodiment

A fifth embodiment of the present invention will now be described. Note that in the following description, similar features (configurations and processing) to the fourth embodiment have been omitted, while features that differ from the fourth embodiment are described in detail. In this embodiment, an example in which a different display mode from those of the first to fourth embodiments is used will be described. More specifically, an example in which a display mode for performing grayscale characteristic control display is used will be described. In grayscale characteristic control display, an image is displayed at a set grayscale characteristic (a correspondence relationship between the grayscale value and the brightness). Note that in the example described below, BL control display and grayscale characteristic control display are used together, but BL control display does not have to be performed.

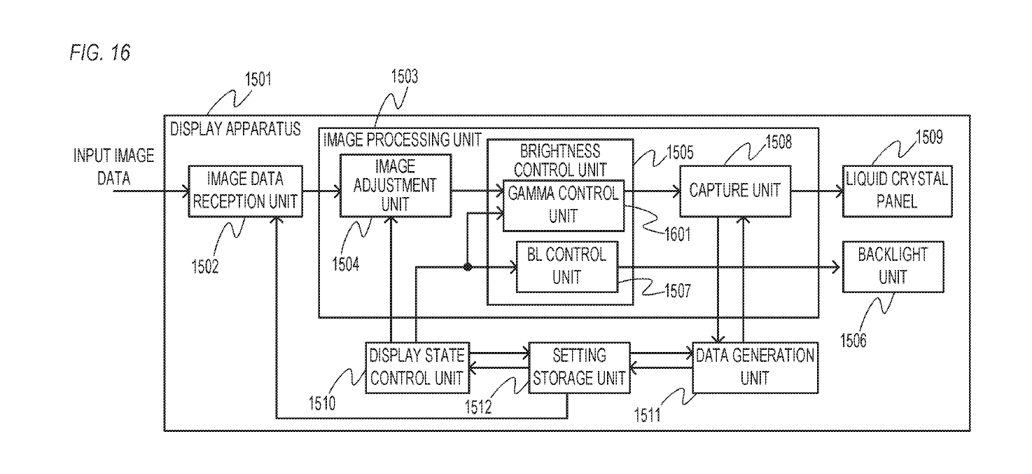

FIG. 16 is a block diagram showing an example configuration of the display apparatus 1501 according to this embodiment. The brightness control unit 1505 of the display apparatus 1501 according to this embodiment further includes a gamma control unit 1601. In FIG. 16, identical function units to the fourth embodiment (FIG. 15) have been allocated identical reference numerals to the fourth embodiment.

The image adjustment unit 1504 according to this embodiment performs similar processing to the fourth embodiment. Note, however, that the image adjustment unit 1504 according to this embodiment outputs the image data to the gamma control unit 1601.

The display state control unit 1510 according to this embodiment performs similar processing to the fourth embodiment. Note, however, that the display state control unit 1510 according to this embodiment also executes the following processing.

The display state control unit 1510 transmits the grayscale characteristic to the gamma control unit 1601. For example, the display state control unit 1510 reads the grayscale characteristic from the setting storage unit 1512 and transmits the read grayscale characteristic to the gamma control unit 1601. The display state control unit 1510 is also capable of transmitting a grayscale characteristic specified by the user to the gamma control unit 1601. The user can issue an instruction to change the grayscale characteristic on the display apparatus 1501. When an instruction to change the grayscale characteristic is issued, the display state control unit 1510 transmits the changed grayscale characteristic to the gamma control unit 1601.

There are no particular limitations on the method of expressing the grayscale characteristic, but in this embodiment, the grayscale characteristic is expressed by a gamma curve, a display range, and a junction. Accordingly, the display state control unit 1510 obtains and transmits gamma curve information, display range information, and junction information as information indicating the grayscale characteristic. The user can also issue instructions to change the gamma curve, the display range, and the junction individually on the display apparatus 1501. The gamma curve, the display range, and the junction will be described in detail below.

The gamma control unit 1601 corrects the image data output from the image adjustment unit 1504 in accordance with the grayscale characteristic (the gamma curve, the display range, and the junction) transmitted from the display state control unit 1510. More specifically, the gamma control unit 1601 converts the grayscale characteristic (the gamma curve, the display range, and the junction) of the image data output from the image adjustment unit 1504 to the grayscale characteristic transmitted from the display state control unit 1510. The gamma control unit 1601 then outputs image data obtained as a result of the grayscale characteristic conversion to the capture unit 1508.

The data generation unit 1511 according to this embodiment performs similar processing to the fourth embodiment. Note, however, that in the data generation unit 1511 according to this embodiment, the following processing is performed after obtaining the capture image data output from the capture unit 1508. Similarly to the fourth embodiment, having obtained the capture image data, the data generation unit 1511 obtains the information indicating the currently set display brightness from the setting storage unit 1512. Furthermore, the data generation unit 1511 obtains information indicating the currently set grayscale characteristic (information indicating the display range and the junction) from the setting storage unit 1512. The data generation unit 1511 then associates the obtained capture image data and the obtained display brightness (the information indicating the display brightness) with the obtained grayscale characteristic (the information indicating the grayscale characteristic) and records the result in the setting storage unit 1512. Note that it is possible to determine from the information indicating the grayscale characteristic that the display mode corresponds to grayscale characteristic control display. Hence, the “information indicating the grayscale characteristic” may also be referred to as “display information indicating the display mode”. Needless to mention, the “information indicating the grayscale characteristic” may also be referred to as “information relating to a parameter indicating the grayscale characteristic”. “information relating to a display parameter used in grayscale characteristic control display”, and so on. Also note that the associated information indicating the grayscale characteristic may further include gamma curve information.

The setting storage unit 1512 according to this embodiment performs similar processing to the fourth embodiment. Note, however, that the setting storage unit 1512 according to this embodiment obtains the information indicating the currently set display brightness and the information indicating the currently set grayscale characteristic (information indicating the display range and the junction) from the display state control unit 1510 as setting information. Further, the capture data according to this embodiment are constituted by information including the mutually associated capture image data, display brightness, and grayscale characteristic.

The gamma curve, the display range, and the junction will now be described. The gamma curve is a gamma curve having a gamma value of 2.2, a log curve having a logarithmic characteristic, an SMPTE ST-2084 curve, or the like, for example. The display range is the brightness range of the display subject, which includes all or a part of the brightness range of the input image data. The display range is set on the basis of the set gamma curve, for example. More specifically, when a log curve is set, all or a part of a brightness range of 0 to 1000% is set as the display range. The realized display brightness (an actual brightness) is determined on the basis of the set display range and the set display brightness.

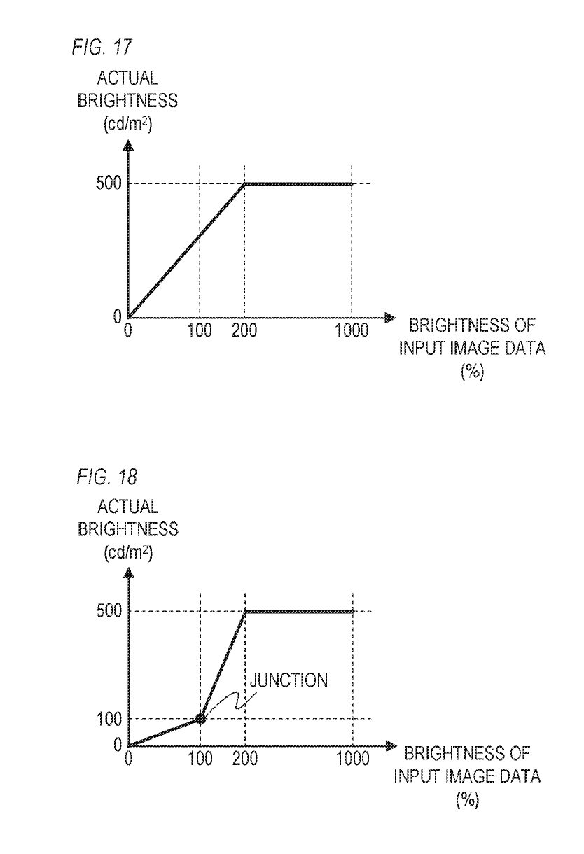

FIG. 17 shows an example of a correspondence relationship between the actual brightness and the brightness of the display range. FIG. 17 shows an example of a case in which the set display brightness is 500 cd/m², a brightness range of 0 to 1000% serves as the brightness range of the input image data, and the set display range is a brightness range of 0 to 200%. In the example shown in FIG. 17, the actual brightness increases linearly from 0 cd/m² to 500 cd/m² as the brightness of the input image data increases from 0% to 200%. Further, in the example shown in FIG. 17, 500 cd/m² is obtained as the actual brightness corresponding to brightnesses (brightnesses of the input image data) higher than 200%. Hence, according to the correspondence relationship shown in FIG. 17, clip display is implemented with a brightness range (a display range) of 0 to 200% as the clip range.

FIG. 18 shows another example of the correspondence relationship between the actual brightness and the brightness of the display range. FIG. 18 shows an example of a case in which the set display brightness is 500 cd/m², a brightness range of 0 to 1000% serves as the brightness range of the input image data, and the set display range is a brightness range of 0 to 200%. Hence, according to the correspondence relationship shown in FIG. 18, clip display is implemented with a brightness range of 0 to 200% as the clip range.

In the example shown in FIG. 18, however, a junction is set. The junction defines the correspondence relationship between the actual brightness and the brightness of the display range. The junction denotes a combination of an actual brightness and a brightness of the display range. In this case, the correspondence relationship between the actual brightness and the brightness of the display range is determined so as to include the set junction. For example, by implementing linear interpolation using a point indicating a minimum brightness of the display range (a combination of the minimum brightness of the display range and the actual brightness) and the junction, the correspondence relationship from the point indicating the minimum brightness to the junction is determined. Further, by implementing linear interpolation using a point indicating a maximum brightness of the display range (a combination of the maximum brightness of the display range and the actual brightness (the set display brightness)) and the junction, the correspondence relationship from the junction to the point indicating the maximum brightness is determined.

In the example shown in FIG. 18, a combination of an actual brightness of 100 cd/m² and a brightness (a brightness of the display range) of 100% is set as the junction. In the example shown in FIG. 18, the actual brightness increases linearly from 0 cd/m² to 100 cd/m² as the brightness of the input image data increases from 0% to 100%. In the example shown in FIG. 18, the actual brightness increases then linearly from 100 cd/m² to 500 cd/m² as the brightness of the input image data increases from 100% to 200%. Further, in the example shown in FIG. 18, 500 cd/m² is obtained as the actual brightness corresponding to brightnesses (brightnesses of the input image data) higher than 200%.

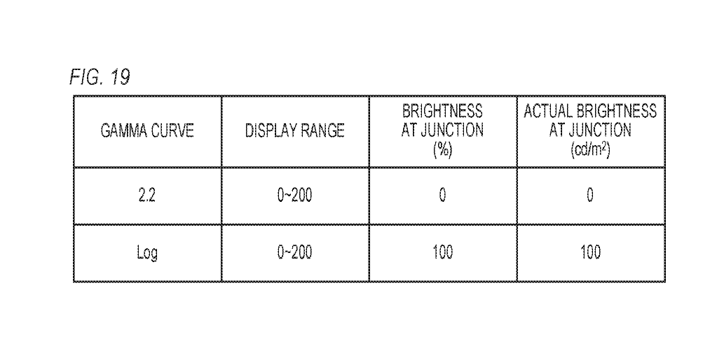

FIG. 19 shows examples of combinations of the gamma curve, the display range, and the junction.

Note that the correspondence relationship between the actual brightness and the brightness of the display range is not limited to the correspondence relationships shown in FIGS. 17 and 18. For example, the actual brightness may vary non-linearly in response to variation in the brightness of the input image data. Combinations of gamma curves, display ranges, and junctions are not limited to the combinations shown in FIG. 19. Further, a plurality of junctions may be set. Moreover, when the brightness range of SDR image data is 0 to 100%, a display emulating a display on an SDR display apparatus can be realized by setting a brightness range of 0 to 100% as the display range.

Processing executed by the respective function units during the capture processing will now be described.

The data generation unit 1511, having obtained the capture image data from the capture unit 1508, obtains the information indicating the currently set display brightness and the information indicating the currently set grayscale characteristic (information indicating the display range and the junction) from the setting storage unit 1512. For example,to realize the correspondence relationship shown in FIG. 18, information indicating “500 cd/m²” is obtained as the information indicating the display brightness. Further, information indicating “200%” is obtained as the information indicating the display range, and information indicating “(brightness of display range, actual brightness)=(100%, (100%, 100 cd/m²)” is obtained as the information indicating the junction. Next, the data generation unit 1511 associates the obtained capture image data and the obtained display brightness (the information indicating the display brightness) with the obtained grayscale characteristic (the information indicating the grayscale characteristic) and records the result in the setting storage unit 1512. For example, when the capture image data are MEG image data, the information indicating the display brightness and the information indicating the grayscale characteristic are described as metadata in the MakerNote of the Exif included in the capture image data. More specifically, to realize the correspondence relationship shown in FIG. 18, “junc=100 (brightness of junction (brightness of display range)), 100 (actual brightness at junction), range=200 (maximum brightness of display range), 500 (display brightness)” is described as the metadata. As a result, capture data including the mutually associated capture image data, display brightness, and grayscale characteristic are generated. All other processing is substantially identical to the fourth embodiment. The processing described above is executed in the gamma control unit 1601 and so on.

Processing executed by the respective function units during capture reproduction will now be described.

The display state control unit 1510 reads the display brightness and grayscale characteristic (the display range and the junction) associated with the reproduction subject capture image data from the setting storage unit 1512. The display state control unit 1510 then transmits the read display brightness to the BL control unit 1507 and transmits the read grayscale characteristic to the gamma control unit 1601. It is assumed here that the gamma curve has already been transmitted. All other processing is substantially identical to the fourth embodiment. The processing described above is executed in the gamma control unit 1601 and so on.

According to this embodiment, an image is displayed by the simple method of associating the capture image data, the display brightness, and the grayscale characteristic with each other, recording the result in the storage unit, and using the recorded display brightness and the recorded grayscale characteristic when the capture image data are reproduced. As a result, a display emulating a display displayed in a past display mode can be realized easily. More specifically, during reproduction of the capture image data, BL control display, in which the emission brightness of the backlight unit is controlled to the same brightness as the brightness thereof during generation of the capture image data, can be implemented easily. Further, during reproduction of the capture image data, grayscale characteristic control display, in which an image is displayed at an identical grayscale characteristic to the grayscale characteristic during generation of the capture image data, can be implemented easily.

### Sixth Embodiment

A sixth embodiment of the present invention will now be described. Note that in the following description, similar features (configurations and processing) to the fourth embodiment have been omitted, while features that differ from the fourth embodiment are described in detail. In this embodiment, an example in which a different display mode from those of the first to fifth embodiments are used will be described. More specifically, an example in which a display mode for performing LD (local dimming)control display is used will be described. LD control display is display control using a display unit having a plurality of light-emitting units that correspond respectively to a plurality of regions (partial regions) of the screen and a display panel that displays images by transmitting the light from the plurality of light-emitting units. More specifically, in LD control display, an image is displayed by controlling the emission brightnesses of the respective light-emitting units individually. A plurality of divided regions forming the region of the screen, for example, are used as the plurality of partial regions.

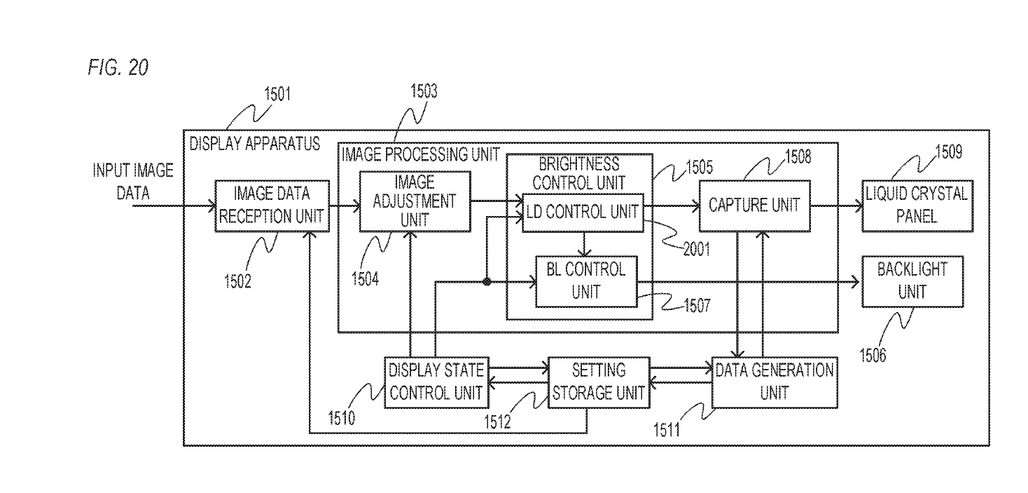

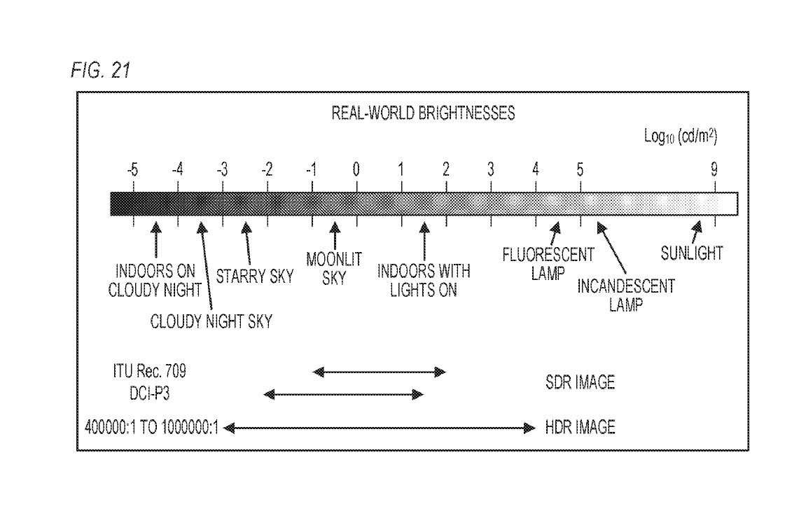

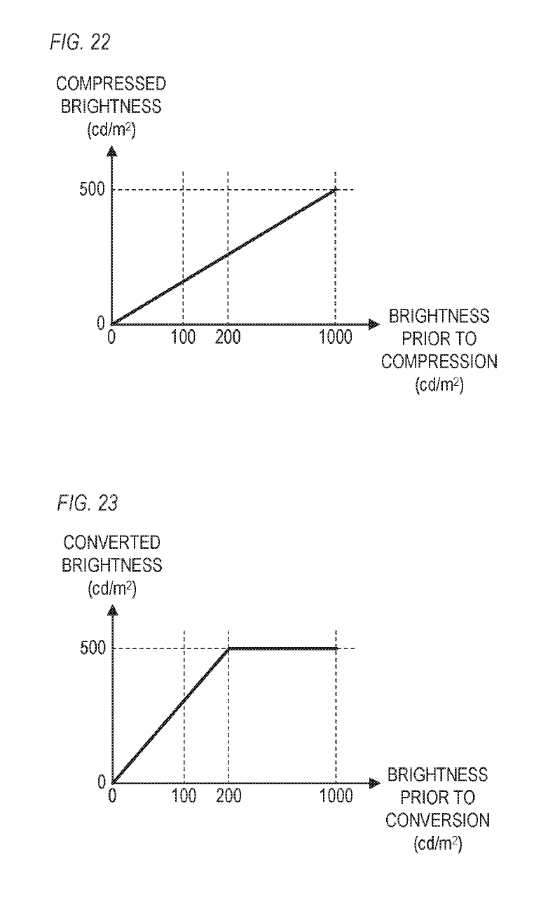

FIG. 20 is a block diagram showing an example configuration of the display apparatus 1501 according to this embodiment. The brightness control unit 1505 of the display apparatus 1501 according to this embodiment further includes an LD control unit 2001. In FIG. 20, identical function units to the fourth embodiment (FIG. 15) have been allocated identical reference numerals to the fourth embodiment.

The image adjustment unit 1504 according to this embodiment performs similar processing to the fourth embodiment. Note, however, that the image adjustment unit 1504 according to this embodiment outputs the image data to the LD control unit 2001,

The display state control unit 1510 according to this embodiment performs similar processing to the fourth embodiment. Note, however, that the display state control unit 1510 according to this embodiment also executes the following processing.

The display state control unit 1510 transmits an LD control value to the LD control unit 2001. For example, the display state control unit 1510 reads the LD control value from the setting storage unit 1512 and transmits the read LD control value to the LD control unit 2001. The display state control unit 1510 is also capable of transmitting an LD control value specified by the user to the LD control unit 2001. The user can issue an instruction to change the LD control value on the display apparatus 1501. When an instruction to change the LD control value is issued, the display state control unit 1510 transmits the changed LD control value to the LD control unit 2001. Moreover, the display state control unit 1510 transmits the display brightness to the LD control unit 2001 as well as the BL control unit 1507.

The LD control value is a parameter indicating the method of LD control (individual control of the respective emission brightnesses of the light-emitting units). For example, one of a plurality of parameters such as “high”, “low”, and “off” is used selectively as the LD control value. By executing LD control, a contrast ratio of the displayed image can be improved. The LD control value “high” is a parameter for greatly increasing the contrast ratio. For example, when the LD control value “high” is used, LD control is executed on the basis that a difference between an upper limit value and a lower limit value of the emission brightnesses of the light-emitting units is large. The LD control value “low” is a parameter for slightly increasing the contrast ratio. For example, when the LD control value “low” is used, LD control is executed on the basis that the difference between the upper limit value and the lower limit value of the emission brightnesses of the light-emitting units is small. The LD control value “off” is a parameter for not executing LD control. For example, when the LD control value “off” is used, the BL control display of the fourth embodiment is executed instead of LD control. Note that when the LD control value “off” is used, the respective emission brightnesses of the light-emitting units may be controlled to a predetermined reference brightness.

The LD control unit 2001 determines the respective emission brightnesses of the light-emitting units on the basis of the image data output from the image adjustment unit 1504, the display brightness transmitted from the display state control unit 1510, and the LD control value transmitted from the display state control unit 1510. For example, when the LD control value “off” is transmitted, the LD control unit 2001 determines one emission brightness corresponding to the transmitted display brightness as the emission brightness of each light-emitting unit. When the LD control value “high” or “low” is transmitted, the LD control unit 2001 determines the respective emission brightnesses of the light-emitting units individually. In this embodiment, the respective emission brightnesses of the light-emitting units are determined individually on the basis of the image data output from the image adjustment unit 1504, the display brightness transmitted from the display state control unit 1510, and the LD control value transmitted from the display state control unit 1510 so as to satisfy the following conditions.

Condition 1: A higher emission brightness than the emission brightness of a light-emitting unit corresponding to a partial region in which a dark image is displayed is used as the emission brightness of a light-emitting unit corresponding to a partial region in which a bright image is displayed.

Condition 2: An emission brightness corresponding to the transmitted display brightness is used as an upper limit value of the emission brightnesses.

Condition 3: An emission brightness corresponding to the transmitted LD control value is used as a lower limit value of the emission brightnesses.

The LD control unit 2001 then transmits the determined emission brightnesses (the respective emission brightnesses of the light-emitting units) to the BL control unit 1507. Further, the LD control unit 2001 outputs the image data from the image adjustment unit 1504 to the capture unit 1508. Note that there are no particular limitations on the method of determining the respective emission brightnesses of the light-emitting units. The LD control unit 2001 may correct the image data from the image adjustment unit 1504 on the basis of the respective emission brightnesses of the light-emitting units and output the corrected image data to the capture unit 1508.

The BL control unit 1507 according to this embodiment executes similar processing to the fourth embodiment. Note, however, that the BL control unit 1507 according to this embodiment generates a control value for each light-emitting unit. More specifically, the BL control unit 1507 generates a control value for each of the plurality of light-emitting units in accordance with the emission brightnesses transmitted from the LD control unit 2001. The BL control unit 1507 then outputs the respective control values of the light-emitting units to the backlight unit 1506. Note that the control values may also be generated while also taking account of the transmitted display brightness.

The backlight unit 1506 according to this embodiment executes similar processing to the fourth embodiment. Note, however, that the backlight unit 1506 according to this embodiment includes the plurality of light-emitting units described above (the plurality of light-emitting units corresponding respectively to the plurality of partial regions). The light-emitting units emit light at emission brightnesses corresponding respectively to the control values output from the BL control unit 1507.

The data generation unit 1511 according to this embodiment executes similar processing to the fourth embodiment. Note, however, that in the data generation unit 1511 according to this embodiment, the following processing is executed after obtaining the capture image data output from the capture unit 1508. Similarly to the fourth embodiment, having obtained the capture image data, the data generation unit 1511 obtains the information indicating the currently set display brightness from the setting storage unit 1512. Further, the data generation unit 1511 obtains the currently set LD control value from the setting storage unit 1512. The data generation unit 1511 then associates the obtained capture image data, the obtained display brightness, and the obtained II) control value with each other and records the result in the setting storage unit 1512. Note that it is possible to determine from the LD control value that the display mode corresponds to LD control display. Hence, the “LD control value” may also be referred to as “display information indicating the display mode”. Needless to mention, the “LD control value” may also be referred to as “information relating to a display parameter used in LD control display” and so on.

The setting storage unit 1512 according to this embodiment executes similar processing to the fourth embodiment. Note, however, that the setting storage unit 1512 according to this embodiment obtains the information indicating the currently set display brightness and the currently set LD control value from the display state control unit 1510 as setting information. Further, the capture data according to this embodiment are constituted by information including the mutually associated capture image data, display brightness, and LD control value.

Processing executed by the respective function units during capture reproduction will now be described.

The data generation unit 1511, having obtained the capture image data from the capture unit 1508, obtains information indicating the currently set display brightness and the currently set LD control value from the setting storage unit 1512. The data generation unit 1511 then associates the obtained capture image data, the obtained display brightness (the information indicating the display brightness), and the obtained LD control value with each other and records the result in the setting storage unit 1512. For example, when the capture image data are JPEG image data, the information indicating the display brightness and the LD control value are described as metadata in the MakerNote of the Exif included in the capture image data. More specifically, “500 (display brightness), High (LD control value)” is described as the metadata. As a result, capture data including the mutually associated capture image data, display brightness, and LD control value are generated. All other processing is substantially identical to the fourth embodiment. The processing described above is executed in the LD control unit 2001 and so on.

Processing executed by the respective function units during capture reproduction will now be described.

The display state control unit 1510 reads the display brightness and the LD control value associated with the reproduction subject capture image data from the setting storage unit 1512. The display state control unit 1510 then transmits the read display brightness to the BL control unit 1507 and the LD control unit 2001, and transmits the read LD control value to the LD control unit 2001. All other processing is substantially identical to the fourth embodiment. The processing described above is executed in the LD control unit 2001 and so on.

According to this embodiment, an image is displayed by the simple method of associating the capture image data, the display brightness, and the LD control value with each other, recording the result in the storage unit, and using the recorded display brightness and the recorded LD control value when the capture image data are reproduced. As a result, a display emulating a display displayed in a past display mode can be realized easily. More specifically, during reproduction of the capture image data, LD control display, in which the respective emission brightnesses of the light-emitting units are controlled to the same brightnesses as the brightnesses thereof during generation of the capture image data, can be implemented easily.

Note that in the first to sixth embodiments, examples in which the apparatus (the display control apparatus) is a display apparatus having a display unit were described, but instead, a separate apparatus may be used as the display unit. Further, in the first to sixth embodiments, examples in which the display unit is an LCD module having a liquid crystal panel and a backlight unit were described, but the display unit is not limited to an LCD module, and another display unit having a light-emitting unit and a display panel that displays images by transmitting light from the light-emitting unit may be used instead. For example, a MEMS (Micro Electro Mechanical System) shutter type display apparatus using a MEMS shutter as a display element may be used. A self-luminous display unit may also be used. An organic EL (Electro-Luminescence) display panel, a plasma display panel, or the like may also be used. Furthermore, the input image data of the respective apparatuses are not limited to photographed image data, and computer graphics image data, illustration image data, and so on may be used as the input image data instead.

Note that the respective function units of the first to sixth embodiments may be, but do not have to be, constituted by individual hardware. The functions of two or more function units may be realized by common hardware. A plurality of functions of a single function unit may be realized by individual hardware. Two or more functions of a single function unit may also be realized by common hardware. Furthermore, the respective function units may be, but do not have to be, realized by hardware. For example, the apparatus may include a processor and a memory storing a control program, and the functions of at least some of the function units of the apparatus may be realized by having the processor read the control program from the memory and execute the program.

According to the present disclosure, a display emulating a display displayed in a past display mode can be realized easily.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A display control apparatus comprising at least one processor that operates as:
a first setting unit configured to set, in response to a user instruction, a processing parameter used for predetermined image processing;
a processing unit configured to generate processed image data by performing the predetermined image processing on input image data using the processing parameter set by the first setting unit;
a second setting unit configured to set a display mode specified by a user from among a plurality of display modes for displaying an image based on the processed image data on a display unit in a brightness range that differs from a brightness range of the input image data; and
a recording unit configured to record, in a storage medium, information relating to the display mode set by the second setting unit together with the processing parameter set by the first setting unit.

2. The display control apparatus according to claim 1, wherein, in a case where two or more display modes are set by the second setting unit,
the first setting unit individually sets two or more processing parameters respectively corresponding to the two or more display modes, and
the recording unit records, in the storage medium, information relating to the two or more display modes set by the second setting unit together with the two or more processing parameters set by the first setting unit.

3. The display control apparatus according to claim 1, wherein, in a case where the display mode set by the second setting unit is a boost display mode for displaying a partial image region at a brightness that is higher than other image regions, the first setting unit sets a processing parameter for the partial image region.

4. The display control apparatus according to claim 3, wherein, in a case where a plurality of image regions are used as the partial image region, the first setting unit individually sets a plurality of processing parameters respectively corresponding to the plurality of image regions.

5. The display control apparatus according to claim 1, wherein the recording unit also records, in the storage medium, at least one of information relating to a color space of the input image data and information relating to a display performance of the display unit together with the processing parameter.

6. The display control apparatus according to claim 1, wherein the plurality of display modes include a compression display mode in which image display is performed while compressing an overall brightness range of the input image data.

7. The display control apparatus according to claim 1, wherein the plurality of display anodes include a clip display mode in which image data corresponding to a part of the brightness range of the input image data is displayed in a set brightness range, and image data not corresponding to the part of the brightness range of the input image data is displayed after being clipped to a predetermined brightness.

8. The display control apparatus according to claim 6, wherein the plurality of display modes further include:
a display mode in which a partial image region is displayed at a brightness that is higher than other image regions;
a display mode in which an image is displayed while controlling an emission brightness of a light-emitting unit of the display unit to a set emission brightness, the display unit comprising the light-emitting unit and a display panel configured to display an image by transmitting light from the light-emitting unit; or
a display mode in which an image is displayed while individually controlling respective emission brightnesses of a plurality of light-emitting units of the display unit, the display unit comprising the plurality of light-emitting units, which respectively correspond to a plurality of regions of a screen, and a display panel for displaying an image by transmitting light from the plurality of light-emitting units.

9. The display control apparatus according to claim 1, wherein the information includes a display parameter used in the display mode set by the second setting unit.

10. The display control apparatus according to claim 6, wherein a display parameter used in the compression display mode includes a parameter indicating a compressed brightness range.

11. The display control apparatus according to claim 7, wherein a display parameter used in the clip display mode includes a parameter indicating the part of the brightness range of the input image data and a parameter indicating the set brightness range.

12. The display control apparatus according to claim 1, wherein the recording unit records the processing parameter in the storage medium in response to change of the display mode set by the second setting unit.

13. The display control apparatus according to claim 1, wherein the input image data is moving image data,
the at least one processor further operates as a generating unit configured to generate a frame displayed by the display unit as still image data, and
the recording unit records, in the storage medium, the still image data together with the processing parameter.

14. The display control apparatus according to claim 1, wherein the predetermined image processing includes image processing relating to color or brightness.

15. The display control apparatus according to claim 1, wherein the predetermined image processing includes image processing defined by the ASC CDL (The American Society of Cinematographers Color Decision List).

16. A display control apparatus comprising at least one processor that operates as:
a setting unit configured to set a display mode specified by a user from among a plurality of display modes for displaying an image based on input image data on a display unit in a brightness range that differs from a brightness range of the input image data;
a control unit configured to execute display control for displaying a moving image based on moving image data on the display unit in the display mode set by the setting unit,
a generating unit configured to generate a frame displayed by the display unit as still image data; and
a recording unit configured to record information relating the display mode set by the setting unit and the still image data in association with each other in a storage medium.

17. A display control apparatus that differs from the display control apparatus according to claim 1, comprising at least one processor that operates as:
an obtaining unit configured to obtain information relating to a display mode, the information being recorded by the display control apparatus according to claim 1; and
a control unit configured to execute display control for displaying an image based on input image data on a display unit on the basis of the information.

18. The display control apparatus according to claim 15, wherein, in a case where a plurality of display modes are related to the information, the display control is display control for displaying on the display unit one or more images respectively corresponding to one or more display modes related to the information.

19. A display control method comprising:
setting, in response to a user instruction, a processing parameter used for predetermined image processing;
generating processed image data by performing the predetermined image processing on input image data using the set processing parameter;
setting a display mode specified by a user from among a plurality of display modes for displaying an image based on the processed image data on a display unit in a brightness range that differs from a brightness range of the input image data; and
recording, in a storage medium, information relating to the set display node together with the set processing parameter.

20. A display control method comprising:
setting a display mode specified by a user from among a plurality of display modes for displaying an image based on input image data on a display unit in a brightness range that differs from a brightness range of the input image data;
executing display control for displaying a moving image based on moving image data on the display unit in the set display mode,
generating a frame displayed by the display unit as still image data; and
recording information relating the set display mode and the still image data in association with each other in a storage medium.
